(19) United States
(12) Patent Application Publication
(10) Pub. No.: US 2018/0180441 A1
(43) Pub. Date: Jun. 28, 2018

(54) REFERENCE VALUE GENERATION METHOD, EXERCISE ANALYSIS METHOD, REFERENCE VALUE GENERATION APPARATUS, AND PROGRAM

(71) Applicant: Seiko Epson Corporation, Shinjuku-ku, Tokyo (JP)

(72) Inventor: Shunichi MIZUOCHI, Matsumoto-shi (JP)

(21) Appl. No.: 15/128,941

(22) PCT Filed: Mar. 12, 2015
(86) PCT No.: PCT/JP2015/001387

§ 371 Date: Sep. 23, 2016

(30) Foreign Application Priority Data
Mar. 25, 2014 (JP) 2014-061551

(51) Int. Cl. G01C 22/00; G01C 21/16

(52) U.S. Cl. CPC G01C 22/006; G06K 9/00348; G01C 21/16

(57) ABSTRACT

Disclosed is a reference value generation method, a reference value generation apparatus, and a program, capable of generating a reference value for estimating errors of indexes indicating a state of a moving object with high accuracy, and an exercise analysis method capable of analyzing a user's exercise with high accuracy. In one aspect, a reference value generation method includes calculating an attitude angle of a moving object by using a detection result in a sensor mounted on the moving object, calculating a tendency estimation formula of an attitude angle by using the attitude angle calculated in a time period in which exercise of the moving object satisfies a predetermined condition, and generating a reference value for estimating errors of indexes indicating a state of the moving object by using the tendency estimation formula.

### CROSS-REFERENCES TO RELATED APPLICATIONS

This application is a National Phase of international Application No. PCT/JP2015/001387, filed Mar. 12, 2015, which claims priority to Japanese Patent Applications No. 2014-061551, filed Mar. 25, 2014, the entireties of which are hereby incorporated by reference.

### BACKGROUND

### Technical Field

The present invention relates to a reference value generation method, an exercise analysis method, a reference value generation apparatus, and a program.

### Background Art

Inertial navigation for calculating a position or a velocity of a moving object by using a detection result in an inertial sensor is widely known. In a case where a person is assumed as the moving object, and an inertial sensor is mounted on the body, when the person moves, an attitude (attitude angle) of the body changes every minute. Therefore, if an attitude angle cannot be accurately estimated, an accurate advancing direction cannot be specified, and thus calculation accuracy of a position or a velocity is reduced.

In a case where an attitude angle is calculated by using a detection result in the inertial sensor, a process of calculating a rotation amount on the basis of the detection result and performing integration (rotational calculation) on the previous attitude angle is repeatedly performed. However, the detection result in the inertial sensor includes a bias error, and thus it is necessary to accurately estimate an error of an attitude angle due to the bias error or the like and to correct the attitude angle. In order to estimate a bias error or an attitude angle error, a reference value used as a criterion is necessary, but, if there is an error in the reference value, an error cannot be accurately estimated. A reference value may be generated by using measurement information in a global positioning system (GPS), but it cannot be said that an accurate reference value is necessarily obtained depending on measurement accuracy or measurement timing in the GPS. Therefore, PTL 1 has proposed a method in which detection values of an attitude, a velocity, angular velocity, and acceleration during a user's movement are stored, a change portion of the past detection values similar to changes in detection values up to the present is extracted, and a reference value is generated by using the extracted result.

### CITATION LIST

### Patent Literature

PTL 1: JP-A-2013-88280

### SUMMARY OF INVENTION

### Technical Problem

However, in the method disclosed in PTL 1, there is a problem in that it is necessary to frequently extract a similar change portion and thus a calculation processing load is large, and, in a case where a difference between a detection value in the similar change portion and a true value is great, accuracy of a reference value is also reduced.

The present invention has been made in consideration of the above-described problems, and, according to some aspects of the present invention, it is possible to provide a reference value generation method, a reference value generation apparatus, and a program, capable of generating a reference value for estimating errors of indexes indicating a state of a moving object with high accuracy, and an exercise analysis method capable of analyzing a user's exercise with high accuracy.

### Solution to Problem

The present invention has been made in order to solve at least some of the above-described problems, and can be realized in the following aspects or application examples.

### APPLICATION EXAMPLE 1

A reference value generation method according to this application example includes calculating an attitude angle of a moving object by using a detection result in a sensor mounted on the moving object; calculating a tendency estimation formula of an attitude angle by using the attitude angle calculated in a time period in which exercise of the moving object satisfies a predetermined condition; and generating a reference value for estimating errors of indexes indicating a state of the moving object by using the tendency estimation formula.

Calculation of a tendency estimation formula may cause parameters for specifying the tendency estimation formula to be easily calculated.

According to the reference value generation method of this application example, it is possible to generate a reference value in which the influence of a variation between detection results is reduced, by using the tendency estimation formula calculated in a time period in which exercise of the moving object satisfies a predetermined condition. Therefore, it is possible to improve estimation accuracy of errors of indexes indicating a state of the moving object by using the reference value which is generated by using the reference value generation method according to the application example.

### APPLICATION EXAMPLE 2

In the reference value generation method according to the application example, the predetermined condition may be that the moving object is advancing straight, and the tendency estimation formula may be calculated by using an attitude angle calculated at a predetermined timing among attitude angles calculated in a time period in which the moving object is advancing straight.

According to the reference value generation method of this application example, attitudes in a straight advancing period have a tendency to be similar to each other. If the tendency estimation formula is calculated in the straight advancing period, the reliability of the tendency estimation formula increases, and thus the accuracy of a reference value improves.

### APPLICATION EXAMPLE 3

The reference value generation method according to the application example may further include detecting a walking cycle of the moving object by using the detection result in the sensor, and the predetermined timing may be a timing synchronized with the walking cycle.

According to the reference value generation method of this application example, since the tendency estimation formula is calculated at a timing at which an attitude angle is nearly constant by using the periodicity of a walking state of the moving object, the reliability of the tendency estimation formula increases, and thus the accuracy of a reference value improves.

### APPLICATION EXAMPLE 4

In the reference value generation method according to the application example, the predetermined condition may be that the moving object stands still, and the tendency estimation formula may be calculated by using an attitude angle calculated in a time period in which the moving object stands still.

According to the reference value generation method of this application example, since the tendency estimation formula is calculated in a stationary period in which the moving object scarcely changes an attitude, the reliability of the tendency estimation formula increases, and thus the accuracy of a reference value improves.

### APPLICATION EXAMPLE 5

In the reference value generation method according to the application example, whether or not the exercise satisfies the predetermined condition may be determined by using the tendency estimation formula.

According to the reference value generation method of this application example, since the tendency estimation formula is used to determine a time period in which the predetermined condition is satisfied (for example, a straight advancing period or a stationary period), direct determination is not required to be performed on the basis of a detection result in the sensor, and thus it is possible to reduce a load of the determination process.

### APPLICATION EXAMPLE 6

In the reference value generation method according to the application example, the tendency estimation formula may be calculated in each time period in which the exercise satisfies the predetermined condition.

According to the reference value generation method of this application example, since the tendency estimation formula may be calculated in each time period in which the predetermined condition is satisfied, for example, even in a case where there is a time period in which exercise of the moving object does not satisfy the predetermined condition, it is possible to maintain the accuracy of a reference value.

### APPLICATION EXAMPLE 7

In the reference value generation method according to the application example, the tendency estimation formula may be a linear regression expression.

In a case where a bias of the sensor is substantially constant, if an actual attitude (attitude angle) of the moving object is nearly constant at a timing at which the tendency estimation formula is calculated, a calculated attitude angle linearly changes by the bias of the sensor. According to the reference value generation method of this application example, since the tendency estimation formula is a linear regression expression, it is possible to estimate a past true attitude (attitude angle) of the moving object with high accuracy and thus to generate a reference value with high accuracy.

### APPLICATION EXAMPLE 8

In the reference value generation method according to the application example, the sensor may include at least one of an acceleration sensor and an angular velocity sensor.

According to the reference value generation method of this application example, it is possible to calculate the tendency estimation formula by using a detection result in the acceleration sensor or the angular velocity sensor.

### APPLICATION EXAMPLE 9

An exercise analysis method according to this application example includes generating the reference value by using any one of the reference value generation methods; estimating the errors by using the reference value; correcting the indexes by using the estimated errors; and analyzing the exercise by using the corrected indexes.

According to the exercise analysis method of this application example, it is possible to estimate errors of indexes indicating a state of the moving object with high accuracy by using the reference value which is generated by using the reference value generation method according to the application example, and thus to analyze exercise of the moving object with high accuracy by using the indexes which are corrected with high accuracy by using the errors.

### APPLICATION EXAMPLE 10

A reference value generation apparatus according to this application example includes an attitude angle calculation portion that calculates an attitude angle of a moving object by using a detection result in a sensor mounted on the moving object; and a tendency estimation formula calculation portion that calculates a tendency estimation formula of an attitude angle by using the attitude angle calculated in a time period in which exercise of the moving object satisfies a predetermined condition, and generates a reference value for estimating errors of indexes indicating a state of the moving object by using the tendency estimation formula.

According to the reference value generation apparatus of this application example, it is possible to generate a reference value in which the influence of a variation between detection results is reduced, by using the tendency estimation formula calculated in a time period in which exercise of the moving object satisfies a predetermined condition. Therefore, it is possible to improve estimation accuracy of errors of indexes indicating a state of the moving object by using the reference value which is generated by using the reference value generation apparatus according to the application example.

### APPLICATION EXAMPLE 11

A program according to this application example causes a computer to execute calculating an attitude angle of a moving object by using a detection result in a sensor mounted on the moving object; calculating a tendency estimation formula of an attitude angle by using the attitude angle calculated in a time period in which exercise of the moving object satisfies a predetermined condition; and generating a reference value for estimating errors of indexes indicating a state of the moving object by using the tendency estimation formula.

According to the program of this application example, it is possible to generate a reference value in which the influence of a variation between detection results is reduced, by using the tendency estimation formula calculated in a time period in which exercise of the moving object satisfies a predetermined condition. Therefore, it is possible to improve estimation accuracy of errors of indexes indicating a state of the moving object by using the reference value which is generated by using the program according to the application example.

### BRIEF DESCRIPTION OF DRAWINGS

FIG. 1 is a diagram illustrating an outline of an exercise analysis system according to the present embodiment.

FIG. 2 is a functional block diagram illustrating configuration examples of an exercise analysis apparatus and a display apparatus.

FIG. 3 is a diagram illustrating configuration example of a sensing data table.

FIG. 4 is a diagram illustrating a configuration example of a GPS data table.

FIG. 5 is a diagram illustrating a configuration example of a calculated data table.

FIG. 6 is a functional block diagram illustrating a configuration example of a processing unit of the exercise analysis apparatus.

FIG. 7 is a diagram illustrating an attitude during a user's walking.

FIG. 8 is a diagram illustrating a yaw angle during the user's walking.

FIG. 9 shows diagrams for explaining a problem of an error estimation method using an attitude angle.

FIG. 10 shows diagrams for explaining an error estimation method according to the present embodiment.

FIG. 11 is a diagram illustrating examples of three-axis accelerations during the user's walking.

FIG. 12 is a diagram illustrating an example of a relationship between a regression line and a yaw angle before being corrected.

FIG. 13 is a flowchart illustrating examples of procedures of an exercise analysis process.

FIG. 14 is a flowchart illustrating examples of procedures of a walking detection process.

FIG. 15 is a flowchart illustrating examples of procedures of a tendency estimation formula calculation process.

FIG. 16 is a flowchart illustrating examples of procedures of a setting information creation process for an error estimation method using an attitude angle.

### DESCRIPTION OF EMBODIMENTS

Hereinafter, preferred embodiments of the present invention will be described in detail with reference to the drawings. The embodiments described below are not intended to improperly limit the content of the present invention disclosed in the claims. It cannot be said that all constituent elements described below are essential constituent elements of the present invention.

1. Exercise Analysis System

1-1. Outline of System

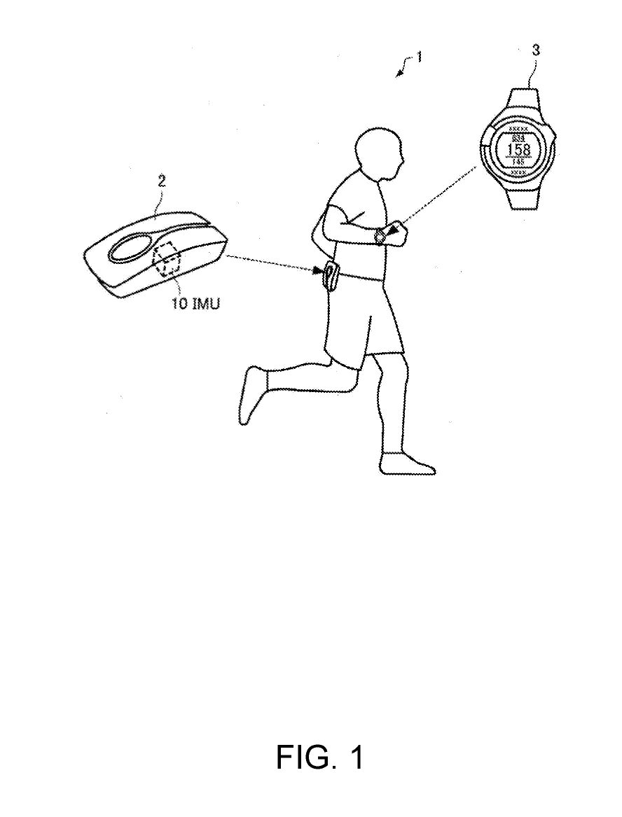

FIG. 1 is a diagram for explaining an outline of an exercise analysis system 1 according to a present embodiment. As illustrated in FIG. 1, the exercise analysis system 1 of the present embodiment includes an exercise analysis apparatus 2 and a display apparatus 3. The exercise analysis apparatus 2 is mounted on a body part (for example, a right-side waist or a left-side waist) of a user (an example of a moving object). The exercise analysis apparatus 2 has an inertial measurement unit (IMU) 10 built thereinto, recognizes motion of the user in walking (including running), computes velocity, a position, attitude angles (a roll angle, a pitch angle, and a yaw angle), and the like, and analyzes a user's exercise so as to generate exercise analysis information. The exercise includes various actions such as straight advancing, curving, and standing still. In the present embodiment, the exercise analysis apparatus 2 is mounted on the user so that one detection axis (hereinafter, referred to as a z axis) of the inertial measurement unit (IMU) 10 substantially matches the gravitational acceleration direction (vertically downward direction) in a state in which the user stands still. The exercise analysis apparatus 2 transmits the generated exercise analysis information to the display apparatus 3.

The display apparatus 3 is a wrist type (wristwatch type) portable information apparatus and is mounted on a user's wrist or the like. However, the display apparatus 3 may be a portable information apparatus such as a head mounted display (HMD) or a smart phone. The user operates the display apparatus 3 so as to instruct the exercise analysis apparatus 2 to start or finish measurement. The display apparatus 3 transmits a command for instructing measurement to be started or finished, to the exercise analysis apparatus 2. If a command for starting measurement has been received, the exercise analysis apparatus 2 causes the inertial measurement unit (IMU) 10 to start measurement, and analyzes the user's exercise on the basis of a measurement result so as to generate exercise analysis information. The exercise analysis apparatus 2 transmits the generated exercise analysis information to the display apparatus 3. The display apparatus 3 receives the exercise analysis information, and presents the received exercise analysis information to the user in various forms such as text, graphics, and sound. The user can recognize the exercise analysis information via the display apparatus 3.

Data communication between the exercise analysis apparatus 2 and the display apparatus 3 may be wireless communication or wired communication.

In the present embodiment, hereinafter, as an example, a detailed description will be made of a case where the exercise analysis apparatus 2 generates exercise analysis information including a movement path, a movement time period, or the like by estimating a walking velocity of the user, but the exercise analysis system 1 of the present embodiment is also applicable to a case where exercise analysis information is generated in exercises causing movement other than walking.

1-2. Coordinate System

Coordinate systems necessary in the following description are defined.

Earth centered earth fixed frame (e frame): right handed three-dimensional orthogonal coordinates in which the center of the earth is set as an origin, and a z axis is taken so as to be parallel to the axis of the earth

Navigation frame (n frame): three-dimensional orthogonal coordinate system in which a moving object (user) is set as an origin, and an x axis is set to the north, a y axis is set to the east, and a z axis is set to the gravitational direction

Body frame (b frame): three-dimensional orthogonal coordinate system using a sensor (the inertial measurement unit (IMU) 10) as a reference

Moving frame (m frame): right handed three-dimensional orthogonal coordinate system in which a moving object (user) is set as an origin, and an advancing direction of the moving object (user) is set as an x axis

1-3. Configuration of System

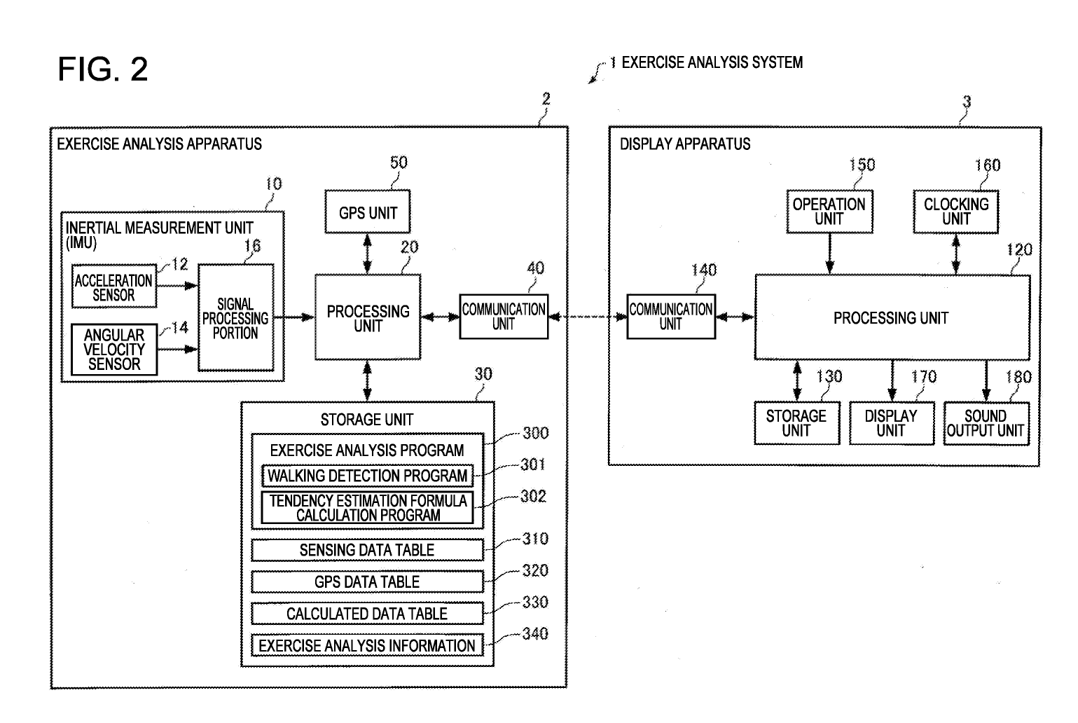

FIG. 2 is a functional block diagram illustrating configuration examples of the exercise analysis apparatus 2 and the display apparatus 3. As illustrated in FIG. 2, the exercise analysis apparatus 2 (an example of a reference value generation apparatus) includes the inertial measurement unit (IMU) 10, a processing unit 20, a storage unit 30, a communication unit 40, and a GPS unit 50. However, the exercise analysis apparatus 2 of the present embodiment may have a configuration in which some of the constituent elements are deleted or changed, or other constituent elements may be added thereto.

The inertial measurement unit 10 (an example of a sensor) includes an acceleration sensor 12, an angular velocity sensor 14, and a signal processing portion 16.

The acceleration sensor 12 detects respective accelerations in the three-axis directions which intersect each other (ideally, orthogonal to each other), and outputs a digital signal (acceleration data) corresponding to magnitudes and directions of the detected three-axis accelerations.

The angular velocity sensor 14 detects respective angular velocities in the three-axis directions which intersect each other (ideally, orthogonal to each other), and outputs a digital signal (angular velocity data) corresponding to magnitudes and directions of the detected three-axis angular velocities.

The signal processing portion 16 receives the acceleration data and the angular velocity data from the acceleration sensor 12 and the angular velocity sensor 14, respectively, adds time information thereto, stores the data items and the time information in a storage unit (not illustrated), generates sensing data in which the stored acceleration data, angular velocity data and time information conform to a predetermined format, and outputs the sensing data to the processing unit 20.

The acceleration sensor 12 and the angular velocity sensor 14 are ideally installed so that three axes thereof match three axes of a sensor coordinate system (b frame) with the inertial measurement unit 10 as a reference, but, in practice, an error occurs in an installation angle. Therefore, the signal processing portion 16 performs a process of converting the acceleration data and the angular velocity data into data of the sensor coordinate system (b frame) by using a correction parameter which is calculated in advance according to the installation angle error. Instead of the signal processing portion 16, the processing unit 20 which will be described later may perform the process.

The signal processing portion 16 may perform a temperature correction process on the acceleration sensor 12 and the angular velocity sensor 14. Instead of the signal processing portion 16, the processing unit 20 to be described later may perform the temperature correction process, and a temperature correction function may be incorporated into the acceleration sensor 12 and the angular velocity sensor 14.

The acceleration sensor 12 and the angular velocity sensor 14 may output analog signals, and, in this case, the signal processing portion 16 may A/D convert an output signal from the acceleration sensor 12 and an output signal from the angular velocity sensor 14 so as to generate sensing data.

The GPS unit 50 receives a GPS satellite signal which is transmitted from a GPS satellite which is one type of positioning satellite, performs positioning computation by using the GPS satellite signal so as to calculate a position and velocity (which is a vector including a magnitude and a direction) of the user in n frames, and outputs GPS data in which time information or positioning accuracy information is added to the calculated results to the processing unit 20. A method of calculating a position or velocity or a method of generating time information by using GPS is well known, and thus detailed description thereof will be omitted.

The processing unit 20 is constituted of, for example, a central processing unit (CPU), a digital signal processor (DSP), or an application specific integrated circuit (ASIC), and performs various calculation processes or control processes according to various programs stored in the storage unit 30. Particularly, the processing unit 20 receives sensing data from the inertial measurement unit 10, and receives GPS data from the GPS unit 50, so as to calculate a velocity, a position, an attitude angle, and the like of the user by using the sensing data and the GPS data. The processing unit 20 performs various calculation processes by using the calculated information so as to analyze exercise of the user and to generate exercise analysis information (image data, text data, sound data, and the like) including a movement path or a movement time period. The processing unit 20 transmits the generated exercise analysis information to the display apparatus 3 via the communication unit 40.

The storage unit 30 is constituted of, for example, recording media including various IC memories such as a read only memory (ROM), a flash ROM, and a random access memory (RAM), a hard disk, and a memory card.

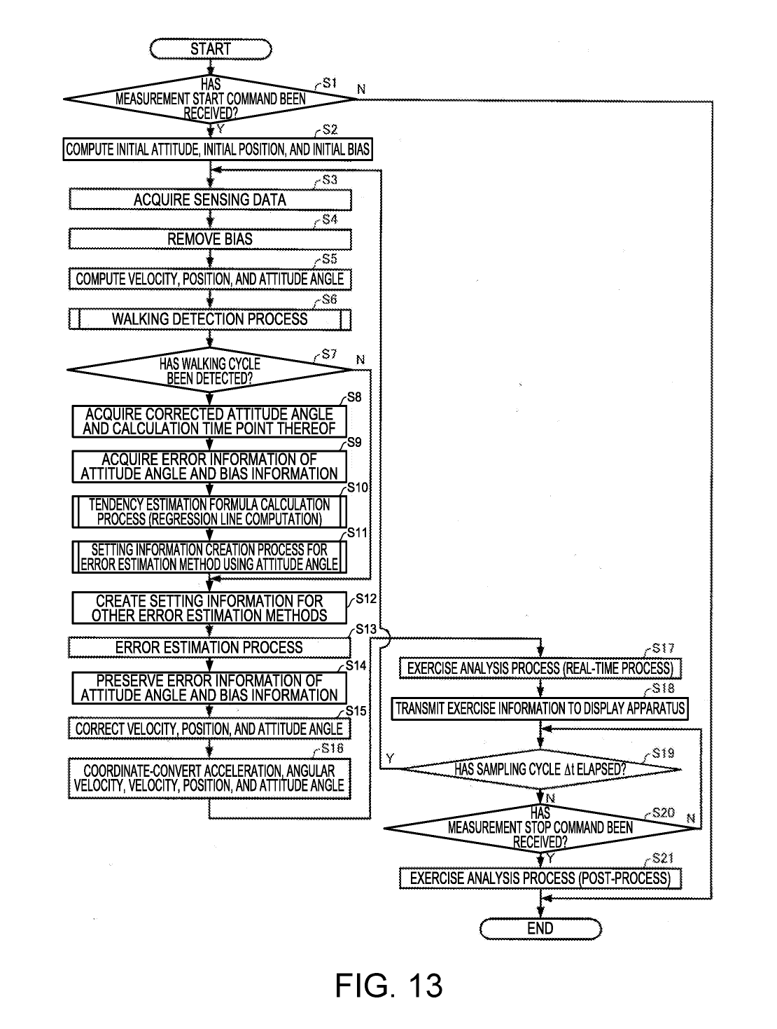

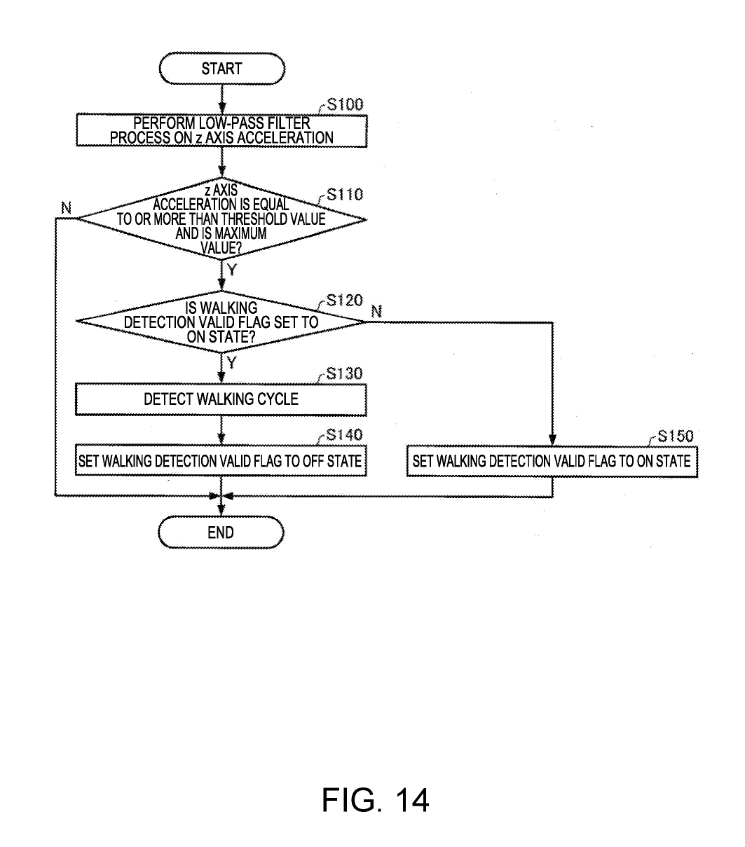

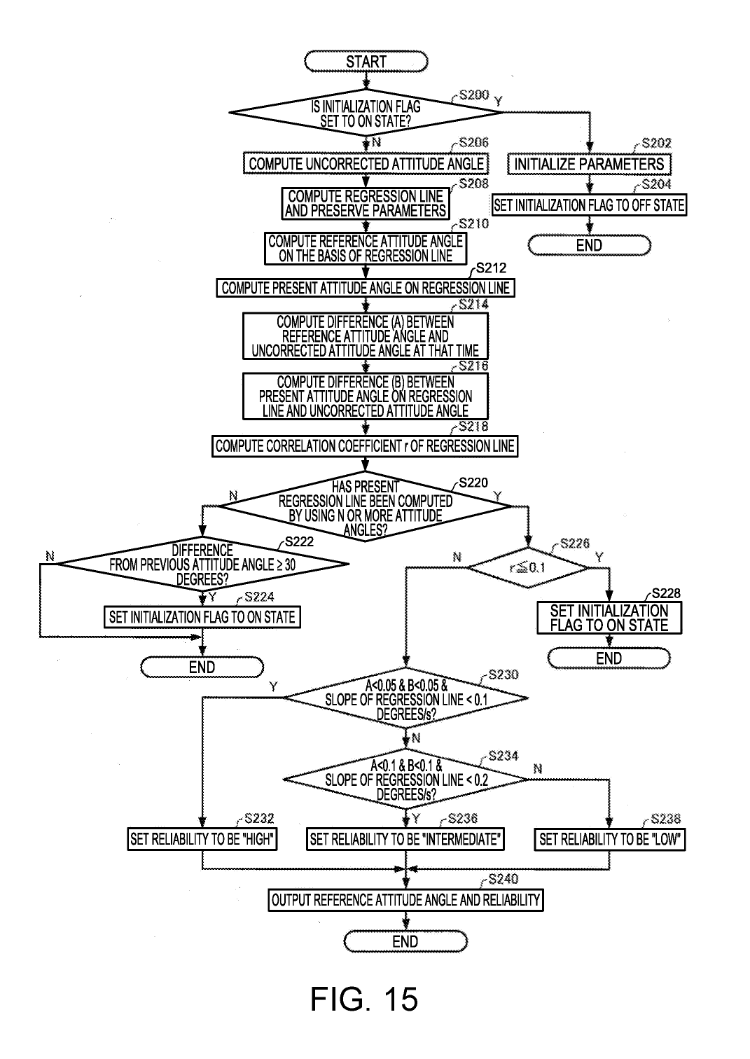

The storage unit 30 stores an exercise analysis program 300 which is read by the processing unit 20 and is used to perform an exercise analysis process (refer to FIG. 13). The exercise analysis program 300 includes, as sub-routines, a walking detection program 301 for executing a walking detection process (refer to FIG. 14) and a tendency estimation formula calculation program 302 for executing a tendency estimation formula calculation process (refer to FIG. 15).

The storage unit 30 stores a sensing data table 310, a GPS data table 320, a calculated data table 330, exercise analysis information 340, and the like.

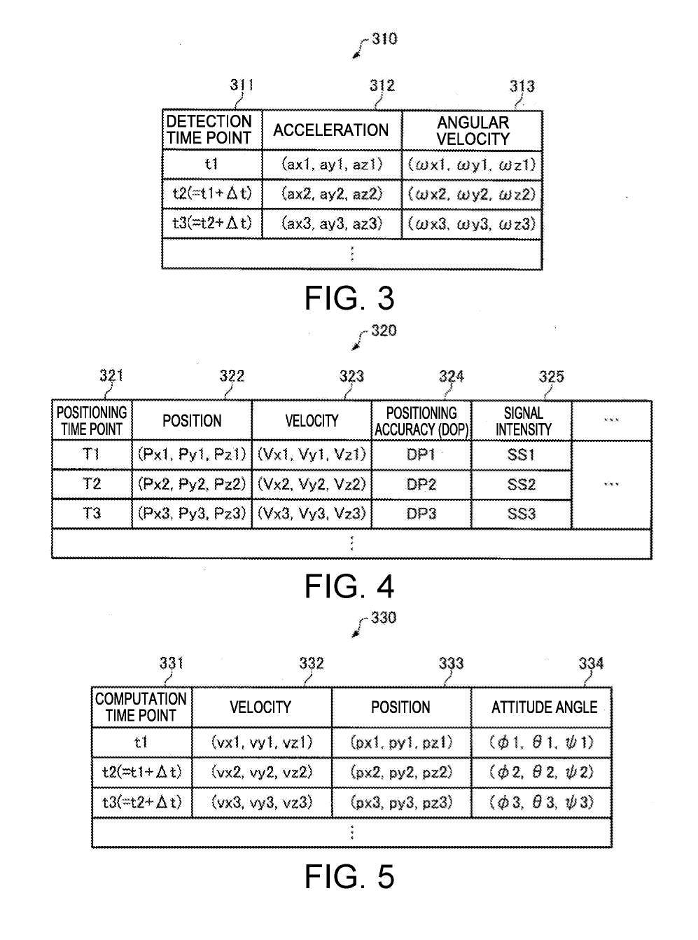

The sensing data table 310 is a data table which stores sensing data (a detection result in the inertial measurement unit 10) received by the processing unit 20 from the inertial measurement unit 10 in a time series. FIG. 3 is a diagram illustrating a configuration example of the sensing data table 310. As illustrated in FIG. 3, the sensing data table 310 is configured so that sensing data items in which the detection time point 311 in the inertial measurement unit 10, an acceleration 312 detected by the acceleration sensor 12, and an angular velocity 313 detected by the angular velocity sensor 14 are correlated with each other are arranged in a time series. When measurement is started, the processing unit 20 adds new sensing data to the sensing data table 310 whenever a sampling cycle Δt (for example, 20 ms) elapses. The processing unit 20 corrects an acceleration and an angular velocity by using an acceleration bias and an angular velocity bias which are estimated according to error estimation (which will be described later) using the extended Karman filter, and updates the sensing data table 310 by overwriting the corrected acceleration and angular velocity to the sensing data table.

The GPS data table 320 is a data table which stores GPS data (a detection result in the GPS unit (GPS sensor) 50) received by the processing unit 20 from the GPS unit 50 in a time series. FIG. 4 is a diagram illustrating a configuration example of the GPS data table 320. As illustrated in FIG. 4, the GPS data table 320 is configured so that GPS data items in which the time point 321 at which the GPS unit 50 performs positioning computation, a position 322 calculated through the positioning computation, a velocity 323 calculated through the positioning computation, positioning accuracy (dilution of precision (DOP)) 324, a signal intensity 325 of a received GPS satellite signal, and the like are correlated with each other are arranged in a time series. When measurement is started, the processing unit 20 adds new GPS data whenever the GPS data is acquired (for example, in an asynchronous manner with acquisition timing of sensing data) so as to update the GPS data table 320.

The calculated data table 330 is a data table which stores a velocity, a position, and an attitude angle calculated by the processing unit 20 by using the sensing data in a time series. FIG. 5 is a diagram illustrating a configuration example of the calculated data table 330. As illustrated in FIG. 5, the calculated data table 330 is configured so that calculated data items in which the time point 331 at which the processing unit 20 performs computation, a velocity 332, a position 333, and an attitude angle 334 are correlated with each other are arranged in a time series. When measurement is started, the processing unit 20 calculates a velocity, a position, and an attitude angle whenever new sensing data is acquired, that is, the sampling cycle At elapses, and adds new calculated data to the calculated data table 330. The processing unit 20 corrects a velocity, a position, and an attitude angle by using a velocity error, a position error, and an attitude angle error which are estimated according to error estimation using the extended Karman filter, and updates the calculated data table 330 by overwriting the corrected velocity, position and attitude angle to the calculated data table.

The exercise analysis information 340 is various information pieces regarding the exercise of the user, and, in the present embodiment, includes information regarding movement due to walking, information regarding an evaluation index of walking exercise, and information regarding advice, an instruction, and a warning for walking, calculated by the processing unit 20.

The communication unit 40 performs data communication with a communication unit 140 of the display apparatus 3, and performs a process of receiving exercise analysis information generated by the processing unit 20 and transmitting the exercise analysis information to the display apparatus 3, a process of receiving a command (a command for starting or finishing measurement, or the like) transmitted from the display apparatus 3 and sending the command to the processing unit 20, and the like.

The display apparatus 3 includes a processing unit 120, a storage unit 130, the communication unit 140, an operation unit 150, a clocking unit 160, a display unit 170, and a sound output unit 180. However, the display apparatus 3 of the present embodiment may have a configuration in which some of the constituent elements are deleted or changed, or other constituent elements may be added thereto.

The processing unit 120 performs various calculation processes or control processes according to a program stored in the storage unit 130. For example, the processing unit 120 performs various processes (a process of sending a command for starting or finishing measurement to the communication unit 140, a process of performing display or outputting sound corresponding to the operation data, and the like) corresponding to operation data received from the operation unit 150; a process of receiving exercise analysis information from the communication unit 140 and sending the exercise analysis information to the display unit 170 or the sound output unit 180; a process of generating time image data corresponding to time information received from the clocking unit 160 and sending the time image data to the display unit 170; and the like.

The storage unit 130 is constituted of various IC memories such as a ROM which stores a program or data required for the processing unit 120 to perform various processes, and a RAM serving as a work area of the processing unit 120.

The communication unit 140 performs data communication with the communication unit 40 of the exercise analysis apparatus 2, and performs a process of receiving a command (a command for starting or finishing measurement, or the like) corresponding to operation data from the processing unit 120 and transmitting the command to the exercise analysis apparatus 2, a process of receiving exercise analysis information (image data, text data, sound data, and the like) transmitted from the exercise analysis apparatus 2 and sending the information to the processing unit 120, and the like.

The operation unit 150 performs a process of acquiring operation data (operation data such as starting or finishing of measurement or selection of display content) from the user and sending the operation data to the processing unit 120. The operation unit 150 may be, for example, a touch panel type display, a button, a key, or a microphone.

The clocking unit 160 performs a process of generating time information such as year, month, day, hour, minute, and second. The clocking unit 160 is implemented by, for example, a real time clock (RTC) IC.

The display unit 170 displays image data or text data sent from the processing unit 120 as text, a graph, a table, animation, or other images. The display unit 170 is implemented by, for example, a display such as a liquid crystal display (LCD), an organic electroluminescence (EL) display, or an electrophoretic display (EPD), and may be a touch panel type display. A single touch panel type display may realize functions of the operation unit 150 and the display unit 170.

The sound output unit 180 outputs sound data sent from the processing unit 120 as sound such as voice or buzzer sound. The sound output unit 180 is implemented by, for example, a speaker or a buzzer.

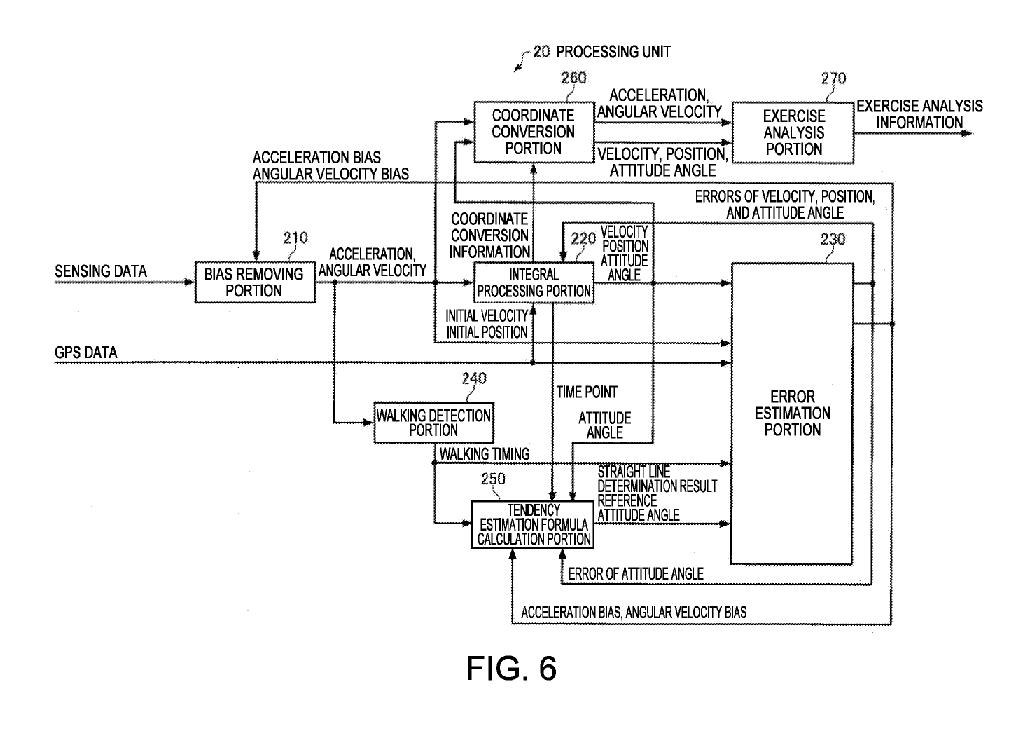

FIG. 6 is a functional block diagram illustrating a configuration example of the processing unit 20 of the exercise analysis apparatus 2. In the present embodiment, the processing unit 20 functions as a bias removing portion 210, an integral processing portion 220, an error estimation portion 230, a walking detection portion 240, a tendency estimation formula calculation portion 250, a coordinate conversion portion 260, and an exercise analysis portion 270, by executing the exercise analysis program 300 stored in the storage unit 30.

The bias removing portion 210 subtracts an acceleration bias bₐ and an angular velocity bias b_{ω} estimated by the error estimation portion 230 from accelerations (three-axis accelerations) and angular velocities included in acquired new sensing data, so as to perform a process of correcting the accelerations and the angular velocities. Since the acceleration bias bₐ and the angular velocity bias b_{ω} are not present in an initial state right after measurement is started, the bias removing portion 210 computes initial biases by using sensing data from the inertial measurement unit assuming that an initial state of the user is a stationary state.

The integral processing portion 220 performs a process of calculating a velocity v^{e}, a position p^{e}, and attitude angles (a roll angle ϕ_{be}, a pitch angle θ_{be}, and a yaw angle ψ_{be}) of the e frame on the basis of the accelerations and the angular velocities corrected by the bias removing portion 210. Specifically, first, the integral processing portion 220 sets an initial velocity to zero assuming that an initial state of the user is a stationary state, or calculates an initial velocity by using the velocity included in the GPS data and also calculates an initial position by using the position included in the GPS data. The integral processing portion 220 specifies a gravitational acceleration direction on the basis of the three-axis accelerations of the b frame corrected by the bias removing portion 210 so as to calculate initial values of the roll angle ϕ_{be} and the pitch angle θ_{be}, also calculates an initial value of the yaw angle ψ_{be} on the basis of the velocity including the GPS data, and sets the calculated initial values as initial attitude angles of the e frame. In a case where the GPS data cannot be obtained, an initial value of the yaw angle ψ_{be} is set to, for example, zero. The integral processing portion 220 calculates an initial value of a coordinate conversion matrix (rotation matrix) C_{b}^{e} from the b frame into the e frame, expressed by Equation (1) on the basis of the calculated initial attitude angles.

$$[ Expression 1 ]$$

$${C}_{b}^{e} = [ \begin{matrix}cos {θ}_{be} \cdot cos {ϕ}_{be} & cos {θ}_{be} \cdot sin {ϕ}_{be} & - sin {θ}_{be} \\ sin {φ}_{be} \cdot sin {θ}_{be} \cdot cos {ϕ}_{be} - cos {φ}_{be} \cdot sin {ϕ}_{be} & sin {φ}_{be} \cdot sin {θ}_{be} \cdot sin {ϕ}_{be} + cos {φ}_{be} \cdot cos {ϕ}_{be} & sin {φ}_{be} \cdot cos {θ}_{be} \\ cos {φ}_{be} \cdot sin {θ}_{be} \cdot cos {ϕ}_{be} + sin {φ}_{be} \cdot sin {ϕ}_{be} & cos {φ}_{be} \cdot sin {θ}_{be} \cdot sin {ϕ}_{be} - sin {φ}_{be} \cdot cos {ϕ}_{be} & cos {φ}_{be} \cdot cos {θ}_{be}\end{matrix} ] \qquad ( 1 )$$

Then, the integral processing portion 220 performs integration (rotation calculation) of the three-axis angular velocities corrected by the bias removing portion 210 so as to calculate the coordinate conversion matrix C_{b}^{e}, and calculates attitude angles by using Equation (2).

$$[ Expression 2 ]$$

$$[ \begin{matrix}{φ}_{be} \\ {θ}_{be} \\ {ϕ}_{be}\end{matrix} ] = [ \begin{matrix}arctan 2 ( {C}_{b}^{e} ( 2 , 3 ) , {C}_{b}^{e} ( 3 , 3 ) ) \\ - arcsin {C}_{b}^{e} ( 1 , 3 ) \\ arctan 2 ( {C}_{b}^{e} ( 1 , 2 ) , {C}_{b}^{e} ( 1 , 1 ) )\end{matrix} ] \qquad ( 2 )$$

The integral processing portion 220 converts the three-axis accelerations of the b frame corrected by the bias removing portion 210 into three-axis accelerations of the e frame by using the coordinate conversion matrix C_{b}^{e}, and removes an gravitational acceleration component therefrom for integration so as to calculate the velocity v^{e} of the e frame. The integral processing portion 220 integrates the velocity v^{e} of the e frame so as to calculate the position p^{e} of the e frame.

The integral processing portion 220 also performs a process of correcting the velocity v^{e}, the position p^{e}, and the attitude angles by using a velocity error δv^{e}, a position error δp^{e}, and attitude angle errors ε^{e} estimated by the error estimation portion 230.

The integral processing portion 220 also calculates a coordinate conversion matrix C_{b}^{m} from the b frame into the m frame, and a coordinate conversion matrix Cₑ^{m} from the e frame into the m frame. The coordinate conversion matrices are used for a coordinate conversion process in the coordinate conversion portion 260 which will be described later as coordinate conversion information.

The error estimation portion 230 estimates an error of an index indicating a state of the user by using the velocity and/or the position, and the attitude angles calculated by the integral processing portion 220, the acceleration or the angular velocity corrected by the bias removing portion 210, the GPS data, and the like. In the present embodiment, the error estimation portion 230 uses the velocity, the attitude angles, the acceleration, the angular velocity, and the position as indexes indicating a state of the user, and estimates errors of the indexes by using the extended Karman filter. In other words, the error estimation portion 230 uses an error (velocity error) δv^{e} of the velocity v^{e} calculated by the integral processing portion 220, errors (attitude angle errors) ε^{e} of the attitude angles calculated by the integral processing portion 220, the acceleration bias bₐ, the angular velocity bias b_{ω}, and an error (position error) δp^{e} of the position p^{e} calculated by the integral processing portion 220, as state variables of the extended Karman filter, and a state vector X is defined as in Equation (3).

$$[ Expression 3 ]$$

$$X = [ \begin{matrix}δ {v}^{e} \\ {ɛ}^{e} \\ {b}_{a} \\ {b}_{ω} \\ δ {p}^{e}\end{matrix} ] \qquad ( 3 )$$

The error estimation portion 230 predicts state variables (errors of the indexes indicating a state of the user) included in the state vector X by using prediction formulae of the extended Karman filter. The prediction formulae of the extended Karman filter are expressed as in Equation (4). In Equation (4), the matrix Φ is a matrix which associates the previous state vector X with the present state vector X, and is designed so that some elements thereof change every moment while reflecting attitude angles, a position, and the like. Q is a matrix indicating process noise, and each element thereof is set to an appropriate value. P is an error covariance matrix of the state variables.

[Expression 4]

X=ΦX

P=ΦPΦ^{T}+Q (4)

The error estimation portion 230 updates (corrects) the predicted state variables (errors of the indexes indicating a state of the user) by using update formulae of the extended Karman filter. The update formulae of the extended Karman filter are expressed as in Equation (5). Z and H are respectively an observation vector and an observation matrix, and the update formulae (5) indicate that the state vector X is corrected by using a difference between the actual observation vector Z and a vector HX predicted from the state vector X. R is a covariance matrix of observation errors, and may have predefined constant values, and may be dynamically changed. K is a Karman gain, and K increases as R decreases. From Equation (5), as K increases (R decreases), a correction amount of the state vector X increases, and thus P decreases.

[Expression 5]

K=PH^{T}(HPH^{T}+R)⁻¹

X=X+K(Z−HX)

P=(I−KH)P (5)

An error estimation method (a method of estimating the state vector X) may include, for example, the following methods.

Error Estimation Method Using Correction Based on Attitude Angle Errors:

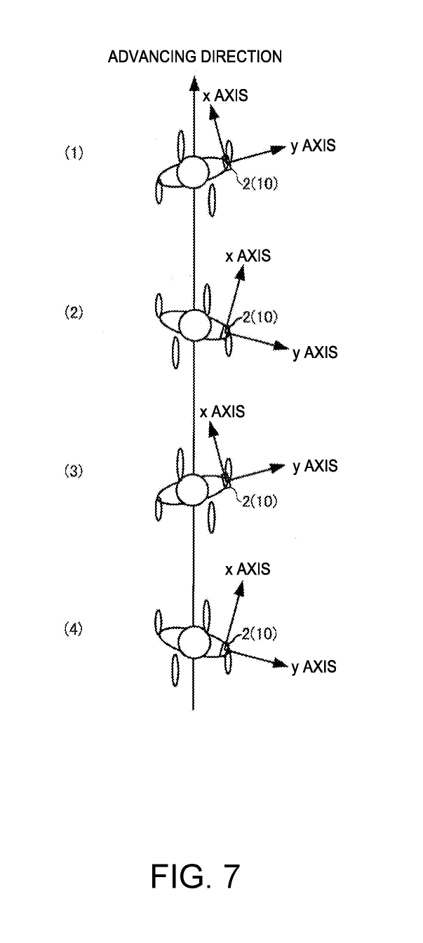

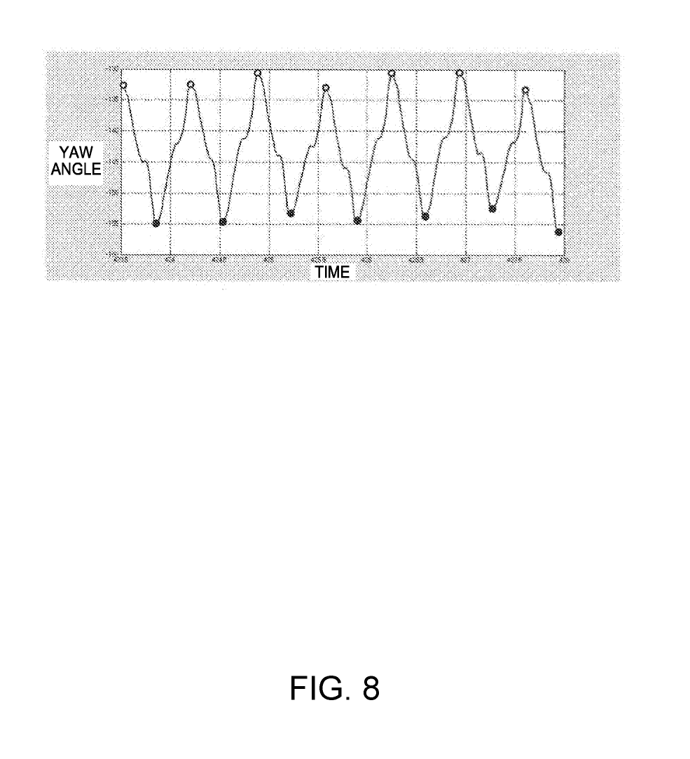

FIG. 7 is an overhead view of movement of the user in a case where the user wearing the exercise analysis apparatus 2 on the user's right waist performs a walking action (advancing straight). FIG. 8 is a diagram illustrating an example of a yaw angle (azimuth angle) calculated by using a detection result in the inertial measurement unit 10 in a case where the user performs the walking action (advancing straight), in which a transverse axis expresses time, and a longitudinal axis expresses a yaw angle (azimuth angle).

An attitude of the inertial measurement unit 10 relative to the user changes at any time due to the walking action of the user. In a state in which the user takes a step forward with the right foot, as illustrated in (2) or (4) of FIG. 7, the inertial measurement unit 10 is tilted to the left side with respect to the advancing direction (the x axis of the m frame). In contrast, in a state in which the user takes a step forward with the left foot, as illustrated in (1) or (3) of FIG. 7, the inertial measurement unit 10 is tilted to the right side with respect to the advancing direction (the x axis of the m frame). In other words, the attitude of the inertial measurement unit 10 periodically changes every two steps including left and right steps due to the walking action of the user. In FIG. 8, for example, the yaw angle is the maximum (indicated by O in FIG. 8) in a state in which the user takes a step forward with the right foot, and is the minimum (indicated by ● in FIG. 8) in a state in which the user takes a step forward with the left foot. Therefore, an error can be estimated assuming that the previous (two steps before) attitude angle is the same as the present attitude angle, and the previous attitude angle is a true attitude angle. In this method, the observation vector Z and the observation matrix H are as in Equation (6). In Equation (6), O_{3,3} is a zero matrix of three rows and three columns, I₃ is a unit matrix of three rows and three columns, and O_{3,9} is a zero matrix of three rows and nine columns. Ψ in Equation (6) is computed according to Equation (7).

$$[ Expression 6 ]$$

$$\begin{matrix}Z = [ \begin{matrix}ψ ( 3 , 2 ) \\ ψ ( 1 , 3 ) \\ ψ ( 2 , 1 )\end{matrix} ] \\ H = [ {O}_{3 , 3} {I}_{3} {O}_{3 , 9} ] \\ [ Expression 7 ] & ( 6 ) \\ ψ = {C}_{b}^{e} ( + ) \cdot {{C}_{b}^{e} ( - )}^{T} - {I}_{3} & ( 7 )\end{matrix}$$

In Equation (7), C_{b}^{e}(+) indicates the present attitude angle, and C_{b}^{e}(−) indicates the previous attitude angle. The observation vector Z in Equation (6) is a difference between the previous attitude angle and the present attitude angle, and the state vector X is corrected on the basis of a difference between the attitude angle error ε^{e} and an observed value according to the update formulae (5) so that an error is estimated.

Error Estimation Method Using Correction Based on the Angular Velocity Bias:

This method is a method of estimating an error assuming that the previous (two steps before) attitude angle is the same as the present attitude angle, and the previous attitude angle is not required to be a true attitude angle. In this method, the observation vector Z and the observation matrix H are as in Equation (8). In Equation (8), O_{3,9} is a zero matrix of three rows and nine columns, I₃ is a unit matrix of three rows and three columns, and O_{3,3} is a zero matrix of three rows and three columns.

$$[ Expression 8 ]$$

$$Z = \frac{{I}_{3} - {{C}_{b}^{e} ( + )}^{T} \cdot {C}_{b}^{e} ( - )}{{τ}_{- +}} \\ H = [ {O}_{3 , 9} {I}_{3} {O}_{3 , 3} ] \qquad ( 8 )$$

In Equation (8), C_{b}^{e}(+) indicates the present attitude angle, and C_{b}^{e}(−) indicates the previous attitude angle. In addition, τ₋₊ is a time period in which the previous attitude angle changes to the present attitude angle. The observation vector Z in Equation (8) is an angular velocity bias calculated on the basis of the previous attitude angle and the present attitude angle, and, in this method, the state vector X is corrected on the basis of a difference between the angular velocity bias b_{ω} and an observed value according to the update formulae (5), so that an error is estimated.

Error Estimation Method Using Correction Based on Azimuth Angle Error:

This method is a method of estimating an error assuming that the previous (two steps before) yaw angle (azimuth angle) is the same as the present yaw angle (azimuth angle), and the previous yaw angle (azimuth angle) is a true yaw angle (azimuth angle). In this method, the observation vector Z and the observation matrix H are expressed as in Equation (9). In Equation (9), O_{1,3} is a zero matrix of one row and three columns, and O_{1,9} is a zero matrix of one row and nine columns. Each partial differentiation in Equation (9) is computed according to Equation (10). Here, n₁, n₂, n₃, d₁, d₂, and d₃ in Equation (10) are computed according to Equation (11).

$$[ Expression 9 ]$$

$$\begin{matrix}Z = {ϕ}_{be} ( + ) - {ϕ}_{be} ( - ) \\ H = [ {O}_{1 , 3} \frac{\partial \hat{ϕ}}{\partial {ɛ}_{x}} \frac{\partial \hat{ϕ}}{\partial {ɛ}_{y}} \frac{\partial \hat{ϕ}}{\partial {ɛ}_{z}} {O}_{1 , 9} ] \\ [ Expression 10 ] & ( 9 ) \\ \frac{\partial \hat{φ}}{\partial {ɛ}_{x}} = \frac{{n}_{1} \cdot {\hat{C}}_{b}^{n} ( 1 , 1 ) - {d}_{1} \cdot {\hat{C}}_{b}^{n} ( 2 , 1 )}{{{\hat{C}}_{b}^{n} ( 2 , 1 )}^{2} + {{\hat{C}}_{b}^{n} ( 1 , 1 )}^{2}} \\ \frac{\partial \hat{φ}}{\partial {ɛ}_{y}} = \frac{{n}_{2} \cdot {\hat{C}}_{b}^{n} ( 1 , 1 ) - {d}_{2} \cdot {\hat{C}}_{b}^{n} ( 2 , 1 )}{{{\hat{C}}_{b}^{n} ( 2 , 1 )}^{2} + {{\hat{C}}_{b}^{n} ( 1 , 1 )}^{2}} \\ \frac{\partial \hat{φ}}{\partial {ɛ}_{z}} = \frac{{n}_{3} \cdot {\hat{C}}_{b}^{n} ( 1 , 1 ) - {d}_{3} \cdot {\hat{C}}_{b}^{n} ( 2 , 1 )}{{{\hat{C}}_{b}^{n} ( 2 , 1 )}^{2} + {{\hat{C}}_{b}^{n} ( 1 , 1 )}^{2}} \\ [ Expression 11 ] & ( 10 ) \\ {n}_{1} = {C}_{e}^{n} ( 2 , 2 ) \cdot {C}_{b}^{e} ( 3 , 1 ) - {C}_{e}^{n} ( 2 , 3 ) \cdot {C}_{b}^{e} ( 2 , 1 ) \\ {n}_{2} = {C}_{e}^{n} ( 2 , 3 ) \cdot {C}_{b}^{e} ( 1 , 1 ) - {C}_{e}^{n} ( 2 , 1 ) \cdot {C}_{b}^{e} ( 3 , 1 ) \\ {n}_{3} = {C}_{e}^{n} ( 2 , 1 ) \cdot {C}_{b}^{e} ( 2 , 1 ) - {C}_{e}^{n} ( 2 , 2 ) \cdot {C}_{b}^{e} ( 1 , 1 ) \\ {d}_{1} = {C}_{e}^{n} ( 1 , 2 ) \cdot {C}_{b}^{e} ( 3 , 1 ) - {C}_{e}^{n} ( 1 , 3 ) \cdot {C}_{b}^{e} ( 2 , 1 ) \\ {d}_{2} = {C}_{e}^{n} ( 1 , 3 ) \cdot {C}_{b}^{e} ( 1 , 1 ) - {C}_{e}^{n} ( 1 , 1 ) \cdot {C}_{b}^{e} ( 3 , 1 ) \\ {d}_{3} = {C}_{e}^{n} ( 1 , 1 ) \cdot {C}_{b}^{e} ( 2 , 1 ) - {C}_{e}^{n} ( 1 , 3 ) \cdot {C}_{b}^{e} ( 1 , 1 ) & ( 11 )\end{matrix}$$

In Equation (9), ψ_{be}(+) is the present yaw angle (azimuth angle), and ψ_{be}(−) is the previous yaw angle (azimuth angle). The observation vector Z in Equation (9) is a difference between the previous azimuth angle and the present azimuth angle, and the state vector X is corrected on the basis of a difference between an azimuth angle error ε_{z}^{e} and an observed value according to the update formulae (5) so that an error is estimated.

Error Estimation Method Using Correction Based on Stoppage:

This method is a method of estimating an error assuming that a velocity is zero when the user stops. In this method, the observation vector Z is a difference between a velocity v^{e} calculated by the integral processing portion 220 and zero, and the state vector X is corrected on the basis of the velocity error δv^{e} according to the update formulae (5) so that an error is estimated.

Error Estimation Method Using Correction Based on Standing Still:

This method is a method of estimating an error assuming that a velocity is zero and an attitude change is also zero when the user stands still. In this method, the observation vector Z is an error of the velocity v^{e} calculated by the integral processing portion 220 and a difference between the previous attitude angle and the present attitude angle calculated by the integral processing portion 220, and the state vector X is corrected on the basis of the velocity error δv^{e} and the attitude angle error ε^{e} according to the update formulae (5) so that an error is estimated.

Error Estimation Method Using Correction Based on Observed Value of GPS:

This method is a method of estimating an error assuming that the velocity v^{e}, the position p^{e}, or the yaw angle ψ_{be} calculated by the integral processing portion 220 is the same as a velocity, a position, or an azimuth angle (a velocity, a position, or an azimuth angle after being converted into the e frame) which is calculated by using GPS data. In this method, the observation vector Z is a difference between a velocity, a position, or a yaw angle calculated by the integral processing portion 220 and a velocity, a positional velocity, or an azimuth angle calculated by using the GPS data, and the state vector X is corrected on the basis of a difference between the velocity error δv^{e}, the position error δp^{e}, or the azimuth angle errors ε_{z}^{e}, and an observed value according to the update formulae (5) so that an error is estimated.

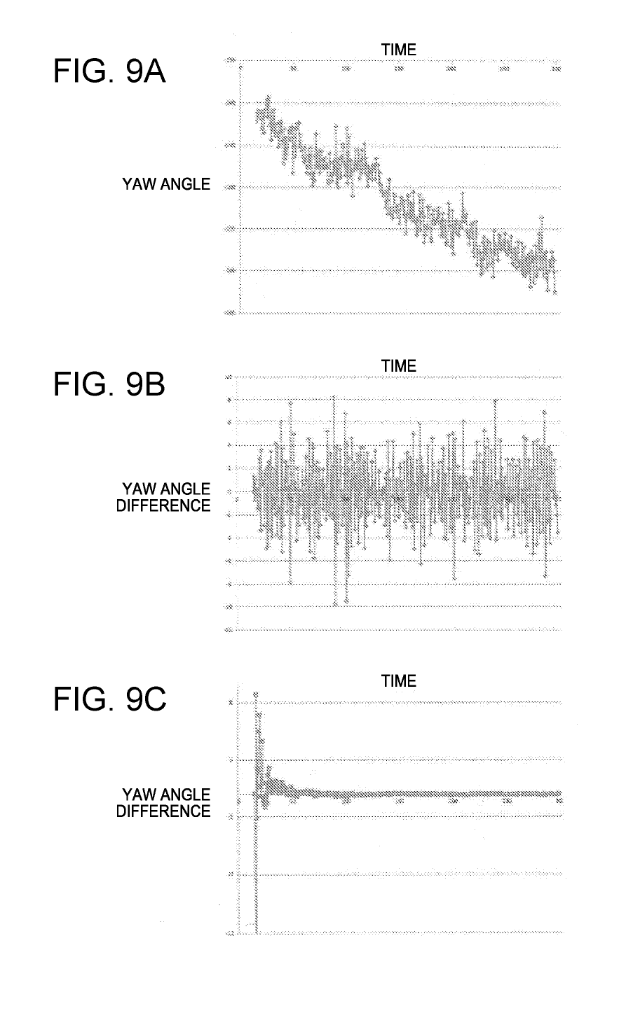

Among the methods, the “error estimation method using correction on the basis of attitude angle errors”, the “error estimation method using correction based on azimuth angle error”, and the “error estimation method using correction based on the angular velocity bias” (hereinafter, collectively referred to as “error estimation methods using attitude angle”) do not require external information such as GPS data, and are also advantageous in terms of being applicable to the time of walking. However, all of these methods have the condition in which the previous attitude angle (azimuth angle) is the same as the present attitude angle (azimuth angle), but, actually, it cannot be said that an identical attitude angle (azimuth angle) is obtained every time. For example, FIG. 9(A) is a diagram illustrating a calculation result of an attitude angle (yaw angle) every two steps (for example, in each state in which a subject takes a step forward with the right foot) when the subject advances straight. FIG. 9(B) is a diagram illustrating a temporal change in a difference between the yaw angle at each time point in FIG. 9(A) and a yaw angle at two steps before. The yaw angle in FIG. 9(A) is calculated without correcting an angular velocity bias, and changes with a slope corresponding to the angular velocity bias. In FIG. 9(B), the difference in the yaw angle considerably changes, and thus does not converge on a constant value. Therefore, it is hard to estimate an accurate angular velocity bias. In other words, it is hard to improve reliability of error estimation in the condition in which the previous attitude angle (azimuth angle) is the same as the present attitude angle (azimuth angle).

Such a method has a problem in that the previous attitude angle which changes every minute is used as a reference attitude angle. Therefore, instead of the previous attitude angle, any one of attitude angles during straight advancing every two steps may be fixed to a reference attitude angle. In order to easily recognize an change in an attitude angle due to a bias, an attitude angle at the time of starting of straight advancing is preferably used as a reference attitude angle. FIG. 9(C) is a diagram illustrating a temporal change in a difference between a yaw angle at each time point in FIG. 9(A) and a yaw angle (the oldest yaw angle) at the time of starting of straight advancing. In FIG. 9(C), the difference in the yaw angle converges on a constant value corresponding to an angular velocity bias over time, and thus it is possible to more accurately estimate the angular velocity bias. Therefore, if an attitude angle at the time of starting of straight advancing is fixed to a reference attitude angle so as to be used, and an error estimation method using an attitude angle is employed, accuracy of error estimation using the extended Karman filter improves.

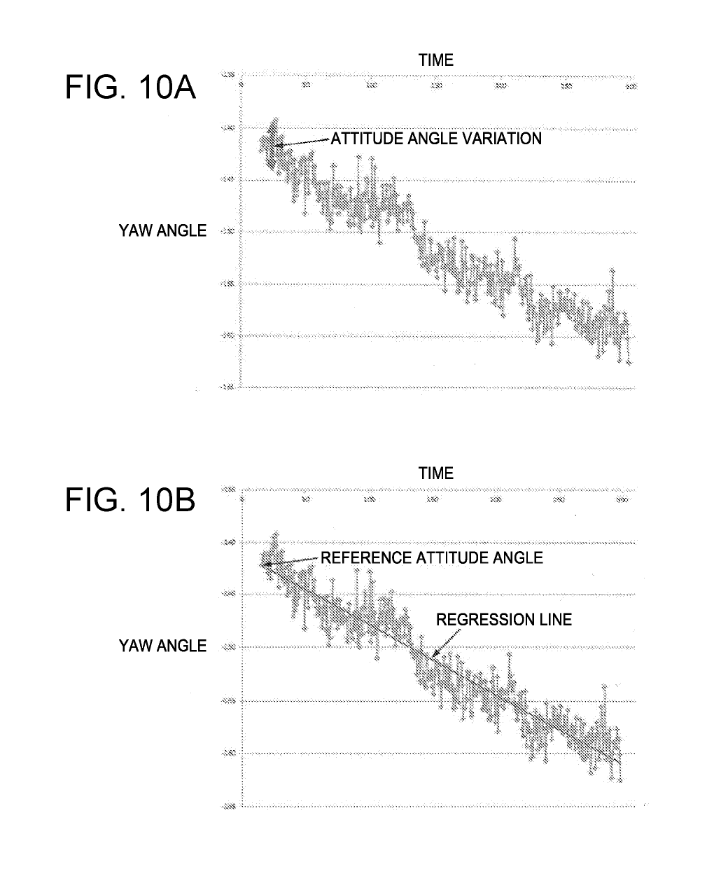

However, there is a variation between yaw angles around the time of starting of straight advancing. For example, FIG. 10(A) is a diagram illustrating a temporal change in the same yaw angle as in FIG. 9(A), but there is a variation in the yaw angle at the time of starting of straight advancing. Thus, there is a high possibility that an attitude angle at the time of starting of straight advancing may also include an error, and if the extended Karman filter is continuously applied with the attitude angle including the error as a reference attitude angle, the error is regarded as an angular velocity bias, and thus there is a limitation in estimation accuracy of the angular velocity bias.

In contrast, if an error of an attitude angle is divided into an error caused by an angular velocity bias and an error caused by a variation, and the error caused by the variation is removed from a reference attitude angle as much as possible, it may be possible to more accurately estimate the angular velocity bias. For example, a tendency estimation formula for estimating an attitude angle obtained by removing an error caused by a variation from changes in attitude angles every two steps from starting of straight advancing up to the present may be dynamically calculated, and an attitude angle calculated by using the tendency estimation formula may be used as a reference attitude angle. For example, FIG. 10(B) is a diagram in which a primary regression line is obtained for the yaw angle in FIG. 9(A), but attitude angles on the regression line have a small error caused by a variation, and a slope of the regression line corresponds to an error caused by an angular velocity data.

Therefore, in the present embodiment, a walking cycle is detected every two steps, a tendency estimation formula is dynamically calculated by using an attitude angle (an uncorrected attitude angle) every two steps, an error estimation method using an attitude angle is applied by using, a reference attitude angle (previous attitude angle), an attitude angle at the time of starting of straight advancing which is computed according to the tendency estimation formula, and error estimation is performed by using the extended Karman filter.

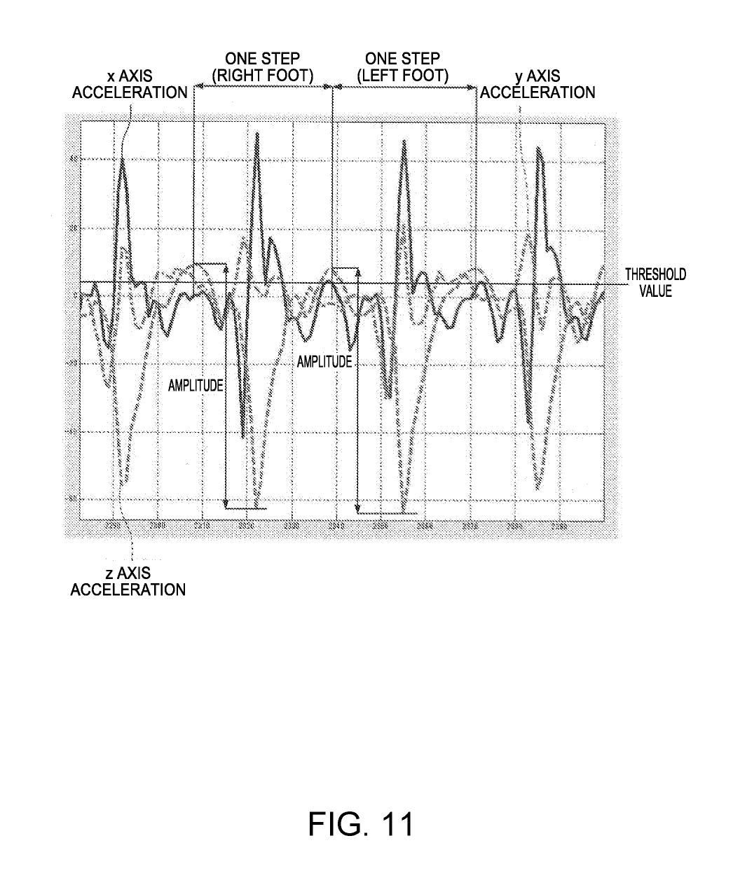

Referring to FIG. 6 again, the walking detection portion 240 performs a process of detecting a walking cycle (walking timing) by using a detection result (specifically, sensing data corrected by the bias removing portion 210) in the inertial measurement unit 10. As described in FIGS. 7 and 8, since the user's attitude periodically changes (every two steps (including left and right steps)) while the user is walking, an acceleration detected by the inertial measurement unit 10 also periodically changes. FIG. 11 is a diagram illustrating examples of three-axis accelerations detected by the inertial measurement unit 10 during the user's walking. In FIG. 11, a transverse axis expresses time, and a longitudinal axis expresses an acceleration value. As illustrated in FIG. 11, the three-axis accelerations periodically change, and, particularly, it can be seen that the z axis (the axis in the gravitational direction) acceleration changes periodically and regularly. The z axis acceleration reflects an acceleration obtained when the user moves vertically, and a time period from the time at which the z axis acceleration becomes the maximum value which is equal to or greater than a predetermined threshold value to the time at which the z axis acceleration becomes the maximum value which is equal to or greater than the predetermined threshold value next corresponds to a time period of one step. One step in a state in which the user takes a step forward with the right foot and one step in a state in which the user takes a step forward with the left foot are alternately taken in a repeated manner.

Therefore, in the present embodiment, the walking detection portion 240 detects a walking cycle every other time whenever the z axis acceleration (corresponding to a vertical movement acceleration of the user) detected by the inertial measurement unit 10 becomes the maximum value which is equal to or greater than the predetermined threshold value. However, actually, since a high frequency noise component is included in the z-axis acceleration detected by the inertial measurement unit 10, the walking detection portion 240 applies a low-pass filter to the z-axis acceleration, and detects a walking cycle by using the z axis acceleration from which noise is removed.

The tendency estimation formula calculation portion 250 performs a process of calculating a tendency estimation formula of an attitude angle by using an attitude angle calculated in a time period satisfying a predetermined condition. Specifically, the tendency estimation formula calculation portion 250 determines whether or not the user is advancing straight as the predetermined condition, and calculates a tendency estimation formula of an attitude angle by using an attitude angle (uncorrected attitude angle) calculated at a predetermined timing among attitude angles calculated by the integral processing portion 220 in a time period in which the user is advancing straight. In the present embodiment, the predetermined timing is a timing synchronized with a timing at which the walking detection portion 240 detects a walking cycle and it may be the same timing which the walking cycle is detected. Since a tendency estimation formula calculated by using a corrected attitude angle has a small slope, straight advancing determination which will be described later cannot be performed by using the tendency estimation formula, or determination accuracy is reduced. Therefore, the tendency estimation formula calculation portion 250 calculates a tendency estimation formula by using an uncorrected attitude angle.

In the present embodiment, a linear regression expression as in Equation (12) is used as the tendency estimation formula by using coefficients a and b. Here, y indicates an uncorrected attitude angle (any one of a roll angle, a pitch angle, and a yaw angle) calculated by the integral processing portion 220, and x indicates a time point corresponding to the attitude angle. The tendency estimation formula calculation portion 250 computes the linear regression expression (12) for each of an uncorrected roll angle, pitch angle, and yaw angle whenever a walking cycle is detected.

[Expression 12]

y=a+bx (12)

Here, a and b are computed as in Equations (13) and (14). In addition, a correlation coefficient r of the regression line is computed as in Equation (15).

$$[ Expression 13 ]$$

$$\begin{matrix}a = \frac{{\sum }_{i = 1}^{n} {y}_{i}}{n} - b \cdot \frac{{\sum }_{i = 1}^{n} {x}_{i}}{n} \\ [ Expression 14 ] & ( 13 ) \\ b = \frac{S ( x , y )}{S ( x , x )} \\ [ Expression 15 ] & ( 14 ) \\ r = \frac{S ( x , y )}{\sqrt{S ( x , x ) \cdot S ( y , y )}} & ( 15 )\end{matrix}$$

S(x,y), S(x,x), and S(y,y) in Equations (14) and (15) are respectively computed according to Equations (16), (17) and (18).

$$[ Expression 16 ]$$

$$\begin{matrix}S ( x , y ) = {\sum }_{i = 1}^{n} ( {x}_{i} - \overline{x} ) ( {y}_{i} - \overline{y} ) = {\sum }_{i = 1}^{n} {x}_{i} {y}_{i} - \frac{( {\sum }_{i = 1}^{n} {x}_{i} ) ( {\sum }_{i = 1}^{n} {y}_{i} )}{n} \\ [ Expression 17 ] & ( 16 ) \\ S ( x , x ) = {\sum }_{i = 1}^{n} {( {x}_{i} - \overline{x} )}^{2} = {\sum }_{i = 1}^{n} {x}_{i}^{2} - \frac{{( {\sum }_{i = 1}^{n} {x}_{i} )}^{2}}{n} \\ [ Expression 18 ] & ( 17 ) \\ S ( y , y ) = {\sum }_{i = 1}^{n} {( {y}_{i} - \overline{y} )}^{2} = {\sum }_{i = 1}^{n} {y}_{i}^{2} - \frac{{( {\sum }_{i = 1}^{n} {y}_{i} )}^{2}}{n} & ( 18 )\end{matrix}$$

If six parameters such as Σxᵢyᵢ, Σxᵢ, Σyᵢ, Σxᵢ², Σyᵢ², and n are computed by using a time point xᵢ and an uncorrected attitude angle yᵢ according to Equations (13) to (18) whenever the integral processing portion 220 calculates (updates) the attitude angle yᵢ, the coefficients a and b, and the correlation coefficient r can be computed (updated). Therefore, in the present embodiment, if the walking detection portion 240 detects a walking cycle, the tendency estimation formula calculation portion 250 updates the six parameters such as Σxᵢyᵢ, Σxᵢ, Σyᵢ, Σxᵢ², Σyᵢ², and n stored in the storage unit 30 by using a time point of detecting the walking cycle and an uncorrected attitude angle calculated by the integral processing portion 220 at the time point, and preserves (stores) the parameters in the storage unit 30. Since the six parameters are preserved, n attitude angles and n time points which are necessary in computation of the linear regression expression (12) are not required to be stored.

In the present embodiment, the tendency estimation formula calculation portion 250 starts computation of a tendency estimation formula at the time of starting of straight advancing, and updates the tendency estimation formula every two steps until the straight advancing is completed.

The tendency estimation formula calculation portion 250 performs a process of generating a reference value (reference attitude angle) for estimating errors (the velocity error δv^{e}, the attitude angle error ε^{e}, the acceleration bias bₐ, the angular velocity bias b_{ω}, and the position error δp^{e}) of indexes indicating a state of the user by using the calculated (updated) tendency estimation formula (linear regression expression (12)). Specifically, the tendency estimation formula calculation portion 250 assigns, for example, a time point (straight advancing starting time point) at which computation of the linear regression expression (12) has been started to x of the linear regression expression (12) so as to calculate a reference attitude angle whenever the linear regression expression (12) is updated.

Here, if the user changes an advancing direction, attitude angles are different from each other before and after the advancing direction is changed, and thus an attitude angle before straight advancing is started cannot be used as a reference attitude angle after the straight advancing is started. Therefore, straight advancing determination is necessary. The straight advancing determination may be performed on the basis of an amount of changes in acceleration or angular velocity detected by the inertial measurement unit 10, but has a problem in terms of determination accuracy, and a method of performing determination with high accuracy has not been established.

The tendency estimation formula calculation portion 250 performs straight advancing determination by using the tendency estimation formula when calculating (updating) the tendency estimation formula (linear regression expression (12)). In the present embodiment, the tendency estimation formula calculation portion 250 determines that straight advancing occurs in a case where all the following four conditions are satisfied by using the linear regression expression (12).

Condition 1: In which a difference (A) between an uncorrected attitude angle and an attitude angle (reference attitude angle) on a regression line at a reference time point (for example) is equal to or less than a predetermined value

Condition 2: In which a difference (B) between an uncorrected attitude angle and an attitude angle on the regression line at the present time point is equal to or less than a predetermined value

Condition 3: In which an absolute value of a slope of the regression line is equal to or smaller than a predetermined value

Condition 4: In which the correlation coefficient r of the regression line is equal to or more than a predetermined value

The condition 1 is a condition which is based on the fact that the difference (A) between two attitude angles at the time of starting of straight advancing increases since a slope of a calculated (updated) regression line changes if the user changes an advancing direction. The condition 2 is a condition which is based on the fact that the difference (B) between two present attitude angles increases since an azimuth changes if the user changes an advancing direction. The condition 3 is a condition which is based on the fact that a slope of a regression line is within a defined range to some extent since the slope of the regression line corresponds to an angular velocity bias during straight advancing. The condition 4 is a condition which is based on the fact that, as the correlation coefficient r of the regression line increases, a difference between each uncorrected attitude angle and an attitude angle on the regression line is reduced, and a state of the user becomes closer to straight advancing.

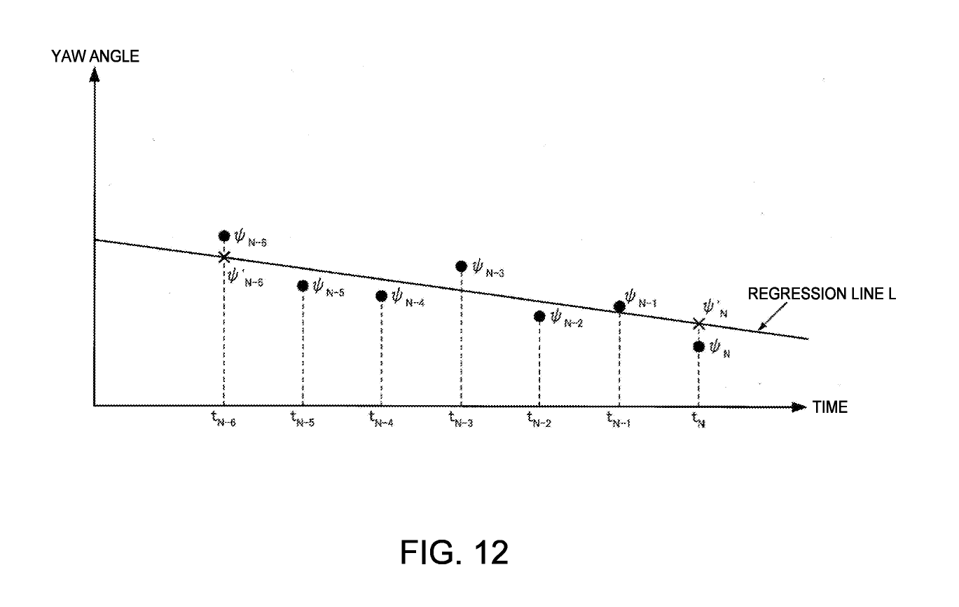

FIG. 12 is a diagram illustrating an example of a relationship between a regression line and an uncorrected yaw angle. In FIG. 12, the present time point is t_{N}, and a reference time point is a time point t_{N-6} corresponding to 12 steps (2 steps×6) before the present. In other words, the time point t_{N-6} is a time point at which straight advancing is started, and is a time point at which computation of a new regression line is started. In the example illustrated in FIG. 12, a regression line L is illustrated in which the coefficients a and b of the regression expression (12) are computed by using seven uncorrected yaw angles ψ_{N-6}, ψ_{N-5}, ψ_{N-4}, ψ_{N-1}, ψ_{N} (indicated by ●) respectively corresponding to time points t_{N-6}, t_{N-5}, t_{N-4}, t_{N-3}, t_{N-2}, t_{N-1}, and t_{N} at the present time point t_{N}. The condition 1 indicates that a difference between the uncorrected yaw angle ψ_{N-6} and a yaw angle ψ′_{N-6} (indicated by x) on the regression line L at the time point t_{N-6} at which the straight line is started is equal to or less than a predetermined value. The condition 2 indicates that a difference between the uncorrected yaw angle ψ_{N} and a yaw angle ψ′_{N} (indicated by x) on the regression line L at the present time point t_{N} is equal to or less than a predetermined value. The condition 3 indicates that the slope (the coefficient a of the regression expression (12)) of the regression line L is equal to or less than a predetermined value. The condition 4 indicates that the correlation coefficient r of the regression line L (regression expression (12)) is equal to or more than a predetermined value.

The tendency estimation formula calculation portion 250 determines that straight advancing occurs if all of the conditions 1 to 4 are satisfied, and the error estimation portion 230 creates the observation vector Z with the yaw angle ψ_{N-6} at the time point t_{N-6} at which the straight line is started as a reference yaw angle, and performs error estimation using the extended Karman filter. The tendency estimation formula calculation portion 250 updates the regression line L and the correlation coefficient r by using an uncorrected attitude angle ψ_{N+1} at two steps later at a time point t_{N+1}.

The tendency estimation formula calculation portion 250 determines that straight advancing does not occur if one or more of the conditions 1 to 4 are not satisfied, and initializes (resets) the parameters Σxᵢ,yᵢ, Σxᵢ, Σyᵢ, Σxᵢ², Σyᵢ², and n (to 0) without updating the regression line L. In this case, the error estimation portion 230 does not create the observation vector Z used in the “error estimation method using attitude angle”. In other words, the “error estimation method using attitude angle” based on the extended Karman filter is not performed.

Actually, the tendency estimation formula calculation portion 250 determines whether or not each of a roll angle, a pitch angle, and a yaw angle satisfies the conditions 1 to 4 by using calculated tendency estimation formulae, and determines that straight advancing occurs in a case where all of the roll angle, the pitch angle, and the yaw angle satisfy the conditions 1 to 4.

In the present embodiment, the error estimation portion 230 creates the observation vector Z and the observation matrix H to which at least an error estimation method using an attitude angle is improved and is applied by using a tendency estimation formula (regression expression), and some or all of the other error estimation methods are further applied, and estimates the state vector X by using the extended Karman filter.

The coordinate conversion portion 260 performs a coordinate conversion process of converting the accelerations and the angular velocities of the b frame corrected by the bias removing portion 210 into accelerations and angular velocities of the m frame, respectively, by using the coordinate conversion information (coordinate conversion matrix C_{b}^{m}) from the b frame into the m frame, calculated by the integral processing portion 220. The coordinate conversion portion 260 performs a coordinate conversion process of converting the velocities, the position, and the attitude angles of the e frame calculated by the integral processing portion 220 into velocities, a position, and attitude angles of the m frame, respectively, by using the coordinate conversion information (coordinate conversion matrix Cₑ^{m}) from the e frame into the m frame, calculated by the integral processing portion 220.

The exercise analysis portion 270 performs a process of various calculations by using the accelerations, the angular velocities, the velocities, the position, and the attitude angles of the m frame obtained through coordinate conversion in the coordinate conversion portion 260, so as to analyze the user's exercise and to generate the exercise analysis information 340. In the present embodiment, the exercise analysis portion 270 generates the exercise analysis information 340 including information regarding movement such as a movement path, a movement velocity, and a movement time, information regarding an evaluation index of walking exercise such as the extent of forward tilt, a difference between left and right motions, propulsion efficiency, an amount of energy consumption, and energy efficiency, information regarding advice or an instruction for better walking, warning information (information for causing the display apparatus 3 to output warning display or warning sound) indicating that an attitude is bad, and the like.

The processing unit 20 transmits the exercise analysis information 340 to the display apparatus 3, and the exercise analysis information 340 is displayed on the display unit 170 of the display apparatus 3 as text, images, graphics, or the like, or is output as voice or buzzer sound from the sound output unit 180. Fundamentally, the exercise analysis information 340 is displayed on the display unit 170, and thus the user can view the display unit 170 and check the exercise analysis information when the user wants to know the exercise analysis information. Information (warning information) which is desired to attract the user's attention is output as at least sound, and thus the user is not required to walk while normally viewing the display unit 170.

1-4. Procedure of Process

FIG. 13 is a flowchart illustrating examples (an example of an exercise analysis method) of procedures of the exercise analysis process performed by the processing unit 20. The processing unit 20 performs the exercise analysis process according to the procedures of the flowchart illustrated in FIG. 13 by executing the exercise analysis program 300 stored in the storage unit 30.

As illustrated in FIG. 13, if a command for starting measurement has been received (Y in step S1), first, the processing unit 20 computes an initial attitude, an initial position, and an initial bias by using sensing data and GPS data measured by the inertial measurement unit 10 assuming that the user stands still (step S2).

Next, the processing unit 20 acquires the sensing data from the inertial measurement unit 10, and adds the acquired sensing data to the sensing data table 310 (step S3).

Next, the processing unit 20 removes biases from acceleration and angular velocity included in the sensing data acquired in step S3 by using the initial bias (by using the acceleration bias bₐ and an angular velocity bias b_{ω} after the bias information (acceleration bias bₐ and the angular velocity bias b_{ω}) is preserved in step S15) so as to correct the acceleration and the angular velocity, and updates the sensing data table 310 by using the corrected acceleration and angular velocity (step S4).

Next, the processing unit 20 integrates the sensing data corrected in step S4 so as to compute a velocity, a position, and an attitude angle, and adds calculated data including the computed velocity, position, and attitude angle to the calculated data table 330 (step S5).

Next, the processing unit 20 performs a walking detection process (step S6). Examples of procedures of the walking detection process will be described later.

In a case where a walking cycle has been detected (Y in step S7) through the walking detection process (step S6), the processing unit 20 acquires a corrected attitude angle and a calculation time point thereof from the storage unit 30 (calculated data table 330) (step S8). The processing unit 20 acquires the error information (attitude angle error ε^{e}) of the attitude angle and the bias information (angular velocity bias b_{ω}) from the storage unit 30 (step S9).

Next, the processing unit 20 performs a tendency estimation formula calculation process (regression line computation) (step S10) and a setting information creation process (step S11) for the error estimation method using attitude angle. Examples of procedures of the tendency estimation formula calculation process (regression line computation) (step S10) and the setting information creation process (step S11) for the error estimation method using attitude angle will be described later.

Next, the processing unit 20 creates setting information (remaining Z, H, R, and the like for error estimation in the extended Karman filter) for the other error estimation methods (the error estimation methods other than the error estimation method using attitude angle) (step S12). In a case where a walking cycle has not been detected (N in step S7), the processing unit 20 does not perform the processes in steps S8 to S11, and performs the process in step S12.

Next, the processing unit 20 performs an error estimation process (step S13), and estimates a velocity error δv^{e}, an attitude angle error ε^{e}, an acceleration bias bₐ, an angular velocity bias b_{ω}, and a position error δp^{e}.

Next, the processing unit 20 preserves (stores) the error information of the attitude angle (attitude angle error ε^{e}) and the bias information (angular velocity bias b_{ω}) obtained through the process in step S13 in the storage unit 30 (step S14).

Next, the processing unit 20 corrects the velocity, the position, and the attitude angle by using the velocity error δv^{e}, the attitude angle error ε^{e}, and the position error δp^{e} calculated in step S13, and updates the calculated data table 330 by using the corrected velocity, position, and attitude angle (step S15).

Next, the processing unit 20 performs coordinate conversion of the sensing data (the acceleration and the angular velocity of the b frame) stored in the sensing data table 310 and the calculated data (the velocity, the position, and the attitude angle of the e frame) stored in the calculated data table 330 into acceleration, angular velocity, velocity, a position, and an attitude angle of the m frame (step S16). The processing unit 20 stores the acceleration, the angular velocity, the velocity, the position, and the attitude angle of the m frame in the storage unit 30 in a time series.

Next, the processing unit 20 analyzes the user's exercise in real time by using the acceleration, the angular velocity, the velocity, the position, and the attitude angle of the m frame obtained through the coordinate conversation in step S16, so as to generate exercise analysis information (step S17).

Next, the processing unit 20 transmits the exercise analysis information generated in step S17 to the display apparatus 3 (step S18). The exercise analysis information transmitted to the display apparatus 3 is fed back in real time during the user's walking. In the present specification, the “real time” indicates that processing is started at a timing at which processing target information is acquired. Therefore, the “real time” also includes some time difference between acquisition of information and completion of processing of the information.

The processing unit 20 repeatedly performs the processes in step S3 and the subsequent steps whenever the sampling cycle At elapses (Y in step S19) from the acquisition of the previous sensing data until a command for finishing the measurement has been received (N in step S19 and N in step S20). If the command for finishing the measurement has been received (Y in step S20), the processing unit analyzes exercise performed by the user by using the acceleration, the angular velocity, the velocity, the position, and the attitude angle of the m frame which are obtained through the coordinate conversion in step S16 and are stored in a time series, or the analysis result in step S17, so as to generate exercise analysis information (step S21). If the command for finishing the measurement has been received, in step S21, the processing unit 20 may immediately perform the exercise analysis process, and may perform the exercise analysis process in a case where an exercise analysis command has been received through a user's operation. The processing unit 20 may transmit the exercise analysis information generated in step S21 to the display apparatus 3, may transmit the exercise analysis information to an apparatus such as a personal computer or a smart phone, and may record the exercise analysis information in a memory card.

In FIG. 13, if a command for starting measurement has not been received (N in step S1), the processing unit 20 does not perform the processes in steps S1 to S21, but may perform the process in step S21 by using the acceleration, the angular velocity, the velocity, the position, and the attitude angle of the m frame stored in the past, or the analysis result in step S17.

FIG. 14 is a flowchart illustrating examples of procedures of the walking detection process (the process in step S6 of FIG. 13). The processing unit 20 (walking detection portion 240) performs the walking detection process according to the procedures of the flowchart illustrated in FIG. 14 by executing the walking detection program 301 stored in the storage unit 30.

As illustrated in FIG. 14, the processing unit 20 performs a low-pass filter process on a z axis acceleration included in the acceleration corrected in step S4 in FIG. 13 (step S100) so as to remove noise therefrom.

Next, in a case where the z axis acceleration having undergone the low-pass filter process in step S100 has a value which is equal to or greater than a threshold value and is the maximum value (Y in step S110), the processing unit 20 detects a walking cycle at this timing (step S130) if a walking detection valid flag is set to an ON state (Y in step S120). The processing unit 20 sets the walking detection valid flag to an OFF state (step S140), and finishes the walking detection process.

Next, in a case where the z axis acceleration has a value which is equal to or greater than the threshold value and is the maximum value (Y in step S110), if the walking detection valid flag is set to an OFF state (N in step S120), the processing unit 20 does not detect a walking cycle, sets the walking detection valid flag to an ON state (step S150), and finishes the walking detection process. If the z axis acceleration has a value which is smaller than the threshold value or is not the maximum value (N in step S110), the processing unit 20 does not perform the processes in step S120 and the subsequent steps, and finishes the walking detection process.

FIG. 15 is a flowchart illustrating examples of procedures of the tendency estimation formula calculation process (regression line computation) (the process in step S10 in FIG. 13). The processing unit 20 (tendency estimation formula calculation portion 250) performs the tendency estimation formula calculation process (regression line computation) according to the procedures of the flowchart illustrated in FIG. 15 by executing the tendency estimation formula calculation program 302 stored in the storage unit 30.

As illustrated in FIG. 15, if an initialization flag is set to an ON state (Y in step S200), the processing unit 20 initializes (resets, to 0) the parameters Σxᵢyᵢ, Σxᵢ², Σyᵢ², and n for calculating the regression expression (12) (step S202), sets the initialization flag to on OFF state (step S204), and finishes the tendency estimation formula calculation process (regression line computation).

If the initialization is set to an OFF state (N in step S200), the processing unit 20 (tendency estimation formula calculation portion 250) computes an uncorrected attitude angle by using the corrected attitude angle acquired in step S8 in FIG. 13, and the error information (attitude angle error ε^{e}) and the bias information (angular velocity bias b_{ω}) acquired in step S9 in FIG. 13 (step S206). If the integral processing portion 220 preserves an uncorrected attitude angle calculated in the storage unit 30, the process in step S206 is not necessary.

Next, the processing unit 20 computes a regression line by using the time point acquired in step S8 in FIG. 13, the uncorrected attitude angle computed in step S206, and the parameters Σxᵢyᵢ, Σxᵢ, Σyᵢ, Σxᵢ², Σyᵢ², and n preserved (or initialized) in the storage unit 30, and preserves obtained parameters Σxᵢyᵢ, Σxᵢyᵢ, Σxᵢ², Σyᵢ², and n (step S208).

Next, the processing unit 20 computes a reference attitude angle on the basis of the regression line computed in step S206 (step S210). The processing unit 20 computes the present attitude angle on the regression line (step S212).

Next, the processing unit 20 computes a difference (A) between the reference attitude angle and the uncorrected attitude angle at that time (step S214). The processing unit 20 computes a difference (B) between the present attitude angle on the regression line and the uncorrected attitude angle (step S216). The processing unit 20 computes the correlation coefficient r of the regression line (step S218).

In a case where the regression line obtained in step S208 is computed by using attitude angles of less than N (for example, less than ten) (N in step S220), if a difference between the previous (two step before) attitude angle and the present attitude angle is equal to or more than 30 degrees (Y in step S222), the processing unit 20 determines that the user has changed the advancing direction, sets the initialization flag to an ON state (step S224), and finishes the tendency estimation formula calculation process (regression line computation). If a difference between the previous (two step before) attitude angle and the present attitude angle is less than 30 degrees (N in step S222), the processing unit 20 finishes the tendency estimation formula calculation process (regression line computation) in a state in which the initialization flag is in an OFF state.

In a case where the regression line obtained in step S208 is computed by using attitude angles of equal to or more than N (for example, equal to or more than ten) (Y in step S220), if the correlation coefficient r computed in step S218 is equal to or more than 0.1 (Y in step S226), the processing unit 20 determines that the user has changed the advancing direction, sets the initialization flag to an ON state (step S228), and finishes the tendency estimation formula calculation process (regression line computation).

In a case where the correlation coefficient r computed in step S218 is equal to or less than 0.1 (N in step S226), if A computed in step S214 is less than 0.05, B computed in step S216 is less than 0.05, and a slope (coefficient a) of the regression line is less than 0.1 degrees/s (Y in step S230), the processing unit 20 sets reliability to be “high” (step S232).

In a case where A computed is equal to or more than 0.05, B is equal to or more than 0.05, or the slope (coefficient a) of the regression line is equal to or more than 0.1 degrees/s (N in step S230), and A is less than 0.1, SB is less than 0.1, and the slope (coefficient a) of the regression line is less than 0.2 degrees/s (Y in step S234), the processing unit 20 sets reliability to be “intermediate” (step S236).

If A is equal to or more than 0.1, B is equal to or more than 0.1, or the slope (coefficient a) of the regression line is equal to or more than 0.2 degrees/s (N in step S234), the processing unit 20 sets reliability to be “low” (step S238).

Processing unit 20 outputs the reference attitude angle computed in step S210, and the reliability set in step S232, S236 or S238 (step S240), and finishes the tendency estimation formula calculation process (regression line computation).

The computation in steps S214, S216 and S218 may be performed only in a case where a determination result in step S220 is affirmative (Y).

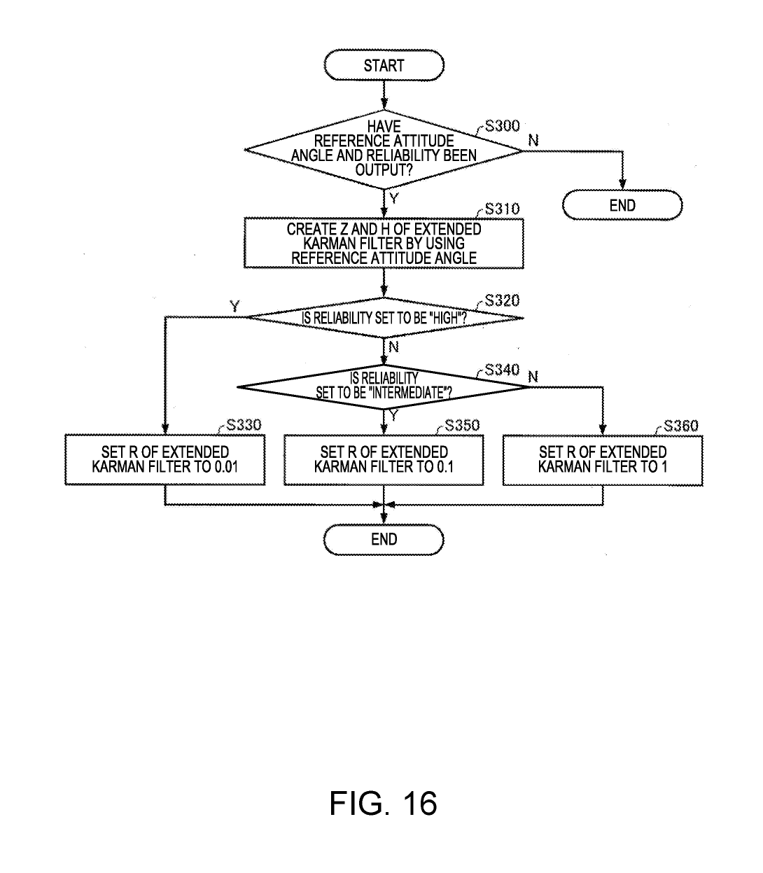

FIG. 16 is a flowchart illustrating examples of procedures of the setting information creation process (the process in step S11 in FIG. 13) for the error estimation method using attitude angle.

As illustrated in FIG. 16, in a case where the reference attitude angle and the reliability are output through the tendency estimation formula calculation process (regression line computation) (the process in step S10 in FIG. 13, and the processes in steps S200 to S240 in FIG. 15) (Y in step S300), the processing unit 20 (the error estimation portion 230) creates the observation vector Z and the observation matrix H of the extended Karman filter by using the output reference attitude angle (step S310).

Next, if the output reliability is set to be “high” (N in step S320), the processing unit 20 sets R of the extended Karman filter to 0.01 (step S330), and finishes the setting information creation process.

If the output reliability is set to be “intermediate” (Y in step S340), the processing unit 20 sets R of the extended Karman filter to 0.1 (step S350), and finishes the setting information creation process.

If the output reliability is set to be “low” (N in step S340), the processing unit 20 sets R of the extended Karman filter to 1 (step S360), and finishes the setting information creation process.

1-5. Effects

According to the present embodiment, it is possible to generate a reference value (reference attitude angle) close to a true attitude angle in which a variation caused by an angular velocity bias is reduced, by using a tendency estimation formula (linear regression expression) calculated in a time period in which the user is advancing straight. Therefore, it is possible to improve estimation accuracy of errors of indexes indicating a state of the user by using the reference value which is generated according to the reference value generation method according to the present application example.

According to the present embodiment, since a tendency estimation formula (linear regression expression) is calculated at a timing at which an attitude angle is nearly constant by using the periodicity of a walking state of the user, the reliability of the tendency estimation formula (linear regression expression) increases, and thus the accuracy of a reference value (reference attitude angle) improves.

According to the present embodiment, a condition based on a tendency estimation formula (linear regression expression) and an attitude angle is determined in the middle of calculating the tendency estimation formula (linear regression expression), and thus it is possible to perform straight advancing determination efficiently and with high accuracy while reducing a load of the determination process. According to the present embodiment, in a case where the user has changed an advancing direction, a process of calculating the tendency estimation formula (linear regression expression) is finished, and error estimation using an attitude angle as a reference value is not performed. Therefore, it is possible to suppress a reduction in error estimation accuracy.

According to the present embodiment, it is possible to correct information such as a velocity, a position, and an attitude angle of the user with high accuracy by using an error which is estimated with high accuracy by using the reference value (reference attitude angle) generated with high accuracy and by applying the extended Karman filter. According to the present embodiment, it is possible to analyze the user's walking exercise with high accuracy by using the information such as the velocity, the position, and the attitude angle which are corrected with high accuracy.

2. Modification Examples

The invention is not limited to the present embodiment, and may be variously modified within the scope of the invention. Hereinafter, modification examples will be described. The same constituent elements as those in the embodiments are given the same reference numerals, and repeated description will be omitted.

2-1. Sensor

In the above-described embodiments, the acceleration sensor 12 and the angular velocity sensor 14 are integrally formed as the inertial measurement unit 10 and are built into the exercise analysis apparatus 2, but the acceleration sensor 12 and the angular velocity sensor 14 may not be integrally formed. Alternatively, the acceleration sensor 12 and the angular velocity sensor 14 may not be built into the exercise analysis apparatus 2, and may be directly mounted on the user. In any case, for example, a sensor coordinate system of one sensor may be set to the b frame of the embodiment, the other sensor coordinate system may be converted into the b frame, and the embodiment may be applied thereto.

In the above-described respective embodiments, a part of which the sensor (the exercise analysis apparatus 2 (the IMU 10)) is mounted on the user has been described to be the waist, but the sensor may be mounted on parts other than the waist. A preferable mounting part is the user's trunk (parts other than the limbs). However, a mounting part is not limited to the trunk, and may be mounted on, for example, the user's head or leg other than the arms.

2-2. Walking Detection

In the above-described embodiment, the walking detection portion 240 detects a walking cycle at a timing at which the vertical movement acceleration (z axis acceleration) of the user becomes the maximum value which is equal to or greater than a threshold value, but is not limited thereto, and may detect a walking cycle at a timing at which the vertical movement acceleration (z axis acceleration) crosses zero while changing from a positive value to a negative value (or a timing at which the z axis acceleration crosses zero while changing from a negative value to a positive value). Alternatively, the walking detection portion 240 may integrate a vertical movement acceleration (z axis acceleration) so as to calculate a vertical movement velocity (z axis velocity), and may detect a walking cycle by using the calculated vertical movement velocity (z axis velocity). In this case, the walking detection portion 240 may detect a walking cycle (walking timing), for example, at a timing at which the velocity crosses a threshold value near the median between the maximum value and the minimum value by increasing or decreasing a value. For example, the walking detection portion 240 may calculate a combined acceleration of accelerations in the x axis, the y axis, and the z axis, and may detect a walking cycle by using the calculated combined acceleration. In this case, the walking detection portion 240 may detect a walking cycle, for example, at a timing at which the combined acceleration crosses a threshold value near the median between the maximum value and the minimum value by increasing or decreasing a value.

2-3. Calculation Condition for Tendency Estimation Formula

In the above-described embodiment, it is determined that straight advancing occurs in a case where the conditions 1 to 4 regarding a tendency estimation formula (regression line) are satisfied, and the tendency estimation formula (regression line) is updated, but a method of determining straight advancing is not limited thereto. For example, it may be determined that straight advancing occurs in a case where some of the conditions 1 to 4 are satisfied, and, since the conditions 1 and 2 influence the accuracy of the straight advancing determination, and thus it may be determined that straight advancing occurs in a case where the conditions 1 and 2 are satisfied. Alternatively, whether or not straight advancing occurs may be determined by using a velocity or a position included in GPS data, acceleration included in sensing data, or the like instead of using the conditions regarding the tendency estimation formula (regression line).

In the above-described embodiment, a tendency estimation formula (regression line) is calculated while the user is advancing straight, but the tendency estimation formula (regression line) may be calculated when the user stands still or stops. When the user stands still or stops, there is no periodicity in an attitude change of the user, and, thus, the tendency estimation formula (regression line) may be calculated, for example, in each sampling cycle Δt. Whether or not the user stands still or stops may be determined depending on whether or not a predetermined condition regarding the tendency estimation formula (regression line) is satisfied, and may be determined by using a velocity or a position included in GPS data, or acceleration or angular velocity included in sensing data. The error estimation portion 230 may perform an error estimation process by using a reference attitude angle which is calculated according to the tendency estimation formula (regression line) when the user stands still. For example, in a case where an attitude change due to subtle motion of the user when standing still is detected by using the tendency estimation formula (regression line), the error estimation portion 230 may not perform the error estimation process.

2-4. Error Estimation

In the above-described embodiment, the error estimation portion 230 performs an error estimation process by using a signal from a GPS satellite, but may perform the error estimation process by using a signal from a positioning satellite of a global navigation satellite system (GNSS) other than the GPS, or a positioning satellite other than the GNSS. Alternatively, the error estimation portion 230 may perform the error estimation process by using a detection signal from a geomagnetic sensor. For example, one, or two or more satellite positioning systems such as a wide area augmentation system (WAAS), a quasi zenith satellite system (QZSS), a global navigation satellite system (GLONASS), GALILEO, a BeiDou navigation satellite system (BeiDou) may be used. An indoor messaging system (IMES) may also be used.

In the above-described embodiments, the error estimation portion 230 uses a velocity, an attitude angle, an acceleration, an angular velocity, and a position as indexes indicating a user's state, and estimates errors of the indexes by using the extended Karman filter, but may estimate the errors thereof by using some of the velocity, the attitude angle, the acceleration, the angular velocity, and the position as indexes indicating a user's state. Alternatively, the error estimation portion 230 may estimate the errors thereof by using parameters (for example, a movement distance) other than the velocity, the attitude angle, the acceleration, the angular velocity, and the position as indexes indicating a user's state.

In the above-described embodiments, the extended Karman filter is used to estimate an error in the error estimation portion 230, but other estimation means such as a particle filter or an H∞ (H infinity) filter may be used.

2-5. Others

In the above-described embodiments, the integral processing portion 220 calculates a velocity, a position, and an attitude angle of the e frame, and the coordinate conversion portion 260 coordinate-converts the velocity, the position, and the attitude angle of the e frame into a velocity, a position, and an attitude angle of the m frame, but the integral processing portion 220 may calculates a velocity, a position, and an attitude angle of the m frame. In this case, the exercise analysis portion 270 may perform an exercise analysis process by using the velocity, the position, and the attitude angle of the m frame calculated by the integral processing portion 220, and thus coordinate conversion of a velocity, a position, and an attitude angle in the coordinate conversion portion 260 is not necessary. The error estimation portion 230 may perform error estimation based on the extended Karman filter by using the velocity, the position, and the attitude angle of the m frame.

In the above-described embodiment, the processing unit 20 generates exercise analysis information such as image data, sound data, and text data, but is not limited thereto, and, for example, the processing unit 20 may transmit a calculation result of propulsion efficiency or an amount of energy consumption, and the processing unit 120 of the display apparatus 3 receiving the calculation result may create image data, sound data, and text data (advice or the like) corresponding to the calculation result.

In the above-described embodiment, the processing unit 20 performs a process (step S21 in FIG. 13) of analyzing exercise performed by the user so as to generate exercise analysis information after a command for stopping measurement is received, but the processing unit 20 may not perform this exercise analysis process (post-process). For example, the processing unit 20 may transmit various information stored in the storage unit 30 to an apparatus such as a personal computer, a smart phone, or a network server, and such an apparatus may perform the exercise analysis process (post-process).

In the above-described embodiment, the display apparatus 3 outputs exercise analysis information from the display unit 170 and the sound output unit 180, but is not limited thereto. For example, a vibration mechanism may be provided in the display apparatus 3, and various information may be output by causing the vibration mechanism to vibrate in various patterns.

In the above-described embodiments, the GPS unit 50 is provided in the exercise analysis apparatus 2 but may be provided in the display apparatus 3. In this case, the processing unit 120 of the display apparatus 3 may receive GPS data from the GPS unit 50 and may transmit the GPS data to the exercise analysis apparatus 2 via the communication unit 140, and the processing unit 20 of the exercise analysis apparatus 2 may receive the GPS data via the communication unit 40 and may add the received GPS data to the GPS data table 320.

In the above-described embodiment, the exercise analysis apparatus 2 and the display apparatus 3 are separately provided, but an exercise analysis apparatus in which the exercise analysis apparatus 2 and the display apparatus 3 are integrally provided may be used.

In the above-described embodiments, the exercise analysis apparatus 2 is mounted on the user but is not limited thereto. For example, an inertial measurement unit (inertial sensor) or a GPS unit may be mounted on the user's body or the like, the inertial measurement unit (inertial sensor) or the GPS unit may transmit a detection result to a portable information apparatus such as a smart phone or an installation type information apparatus such as a personal computer, and such an apparatus may analyze exercise of the user by using the received detection result. Alternatively, an inertial measurement unit (inertial sensor) or a GPS unit which is mounted on the user's body or the like may record a detection result on a recording medium such as a memory card, and an information apparatus such as a smart phone or a personal computer may read the detection result from the recording medium and may perform an exercise analysis process.

In the above-described embodiments, exercise in human walking is an object of analysis, but the present invention is not limited thereto, and is also applicable to walking of a moving object such as an animal or a walking robot. The present invention is not limited to walking, and is applicable to various exercises such as climbing, trail running, skiing (including cross-country and ski jumping), snowboarding, swimming, bicycling, skating, golf, tennis, baseball, and rehabilitation.

The above-described embodiment and the modification examples are only examples, and the present invention is not limited thereto. For example, the embodiment and the modification examples may be combined with each other as appropriate.

The present invention includes the substantially same configuration (for example, a configuration having the same function, method, and result, or a configuration having the same object and effect) as the configuration described in the embodiment. The present invention includes a configuration in which a non-essential part of the configuration described in the embodiment is replaced. The present invention includes a configuration which achieves the same operation and effect or a configuration which can achieve the same object as the configuration described in the embodiment. The present invention includes a configuration in which a well-known technique is added to the configuration described in the embodiment.

### REFERENCE SIGNS LIST

1 EXERCISE ANALYSIS SYSTEM

2 EXERCISE ANALYSIS APPARATUS

3 DISPLAY APPARATUS

10 INERTIAL MEASUREMENT UNIT (IMU)

12 ACCELERATION SENSOR

14 ANGULAR VELOCITY SENSOR

16 SIGNAL PROCESSING PORTION

20 PROCESSING UNIT

30 STORAGE UNIT

40 COMMUNICATION UNIT

50 GPS UNIT

120 PROCESSING UNIT

130 STORAGE UNIT

140 COMMUNICATION UNIT

150 OPERATION UNIT

160 CLOCKING UNIT

170 DISPLAY UNIT

180 SOUND OUTPUT UNIT

210 BIAS REMOVING PORTION

220 INTEGRAL PROCESSING PORTION

230 ERROR ESTIMATION PORTION

240 WALKING DETECTION PORTION

250 TENDENCY ESTIMATION FORMULA CALCULATION PORTION

260 COORDINATE CONVERSION PORTION

270 EXERCISE ANALYSIS PORTION

1. A reference value generation method comprising:
calculating an attitude angle of a moving object by using a detection result in a sensor mounted on the moving object;
calculating a tendency estimation formula of an attitude angle by using the attitude angle calculated in a time period in which exercise of the moving object satisfies a predetermined condition; and
generating a reference value for estimating errors of indexes indicating a state of the moving object by using the tendency estimation formula.

2. The reference value generation method according to claim 1,
wherein the predetermined condition is that the moving object is advancing straight, and
wherein the tendency estimation formula is calculated by using an attitude angle calculated at a predetermined timing among attitude angles calculated in a time period in which the moving object is advancing straight.

3. The reference value generation method according to claim 2, further comprising:
detecting a walking cycle of the moving object by using the detection result in the sensor, wherein the predetermined timing is a timing synchronized with the walking cycle.

4. The reference value generation method according to claim 1,
wherein the predetermined condition is that the moving object stands still, and
wherein the tendency estimation formula is calculated by using an attitude angle calculated in a time period in which the moving object stands still.

5. The reference value generation method according to claim 1,
wherein whether or not the exercise satisfies the predetermined condition is determined by using the tendency estimation formula.

6. The reference value generation method according to claim 1,
wherein the tendency estimation formula is calculated in each time period in which the exercise satisfies the predetermined condition.

7. The reference value generation method according to claim 1,
wherein the tendency estimation formula is a linear regression expression.

8. The reference value generation method according to claim 1,
wherein the sensor includes at least one of an acceleration sensor and an angular velocity sensor.

9. An exercise analysis method comprising:
generating the reference value by using the reference value generation method according to claim 1;
estimating the errors by using the reference value;
correcting the indexes by using the estimated errors; and
analyzing the exercise by using the corrected indexes.

10. A reference value generation apparatus comprising:
an attitude angle calculation portion that calculates an attitude angle of a moving object by using a detection result in a sensor mounted on the moving object; and
a tendency estimation formula calculation portion that calculates a tendency estimation formula of an attitude angle by using the attitude angle calculated in a time period in which exercise of the moving object satisfies a predetermined condition, and generates a reference value for estimating errors of indexes indicating a state of the moving object by using the tendency estimation formula.

11. A program causing a computer to execute:
calculating an attitude angle of a moving object by using a detection result in a sensor mounted on the moving object;
calculating a tendency estimation formula of an attitude angle by using the attitude angle calculated in a time period in which exercise of the moving object satisfies a predetermined condition; and
generating a reference value for estimating errors of indexes indicating a state of the moving object by using the tendency estimation formula.
